(19) United States
(12) Patent Application Publication
(10) Pub. No.: US 2024/0104701 A1
(43) Pub. Date: Mar. 28, 2024

(54) SYSTEM AND METHOD FOR NON-INVASIVE VISUALIZATION AND CHARACTERIZATION OF LUMEN STRUCTURES AND FLOW THEREWITHIN

(71) Applicant: Imago Systems, Inc.,, Lansdowne, VA (US)

(72) Inventors: Gene Ramsay, Tucson, AZ (US); Thomas E. Ramsay, Leesburg, VA (US); Karen Morgan, Leesburg, VA (US); Oleksandr Andrushchenko, Toronto (CA); Anna Yang, Midlothian, VA (US); Jermaine Headley, Charlottesville, VA (US); Victor Krivorotov, Reston, VA (US); Gennadiy Lyashenko, Toronto (CA)

(73) Assignee: Imago Systems, Inc.,, Lansdowne, VA (US)

(21) Appl. No.: 18/469,414

(22) Filed: Sep. 18, 2023

Related U.S. Application Data
(60) Provisional application No. 63/375,989, filed on Sep. 16, 2022.

(51) Int. Cl. G06T 5/00; G06T 5/40

(52) U.S. Cl. CPC G06T 5/002; G06T 5/40; G06T 2207/10024; G06T 2207/10048; G06T 2207/10081; G06T 2207/10116; G06T 2207/10132; G06T 2207/30048; G06T 2207/30104

(57) ABSTRACT

A method for visualizing luminance variance for an object may include receiving image data associated with a digital image of the object. An algorithm is applied to the image data to generate an enhanced image. The enhanced image includes connected pixel value lines representative of pixel value ranges from the input image to enable visualization of luminance variance of the object by the human eye.

### CROSS-REFERENCE TO RELATED APPLICATIONS

The present application claims the benefit of priority to U.S. Provisional Patent Application No. 63/375,989, filed on Sep. 16, 2022, which is incorporated herein by reference by its entirety for all purposes.

### TECHNICAL FIELD

The present disclosure relates to image processing, more specifically, to the processing of grayscale images of objects to enhance the visualization of flow patterns and variances in the objects.

### BACKGROUND

Analysis of heart and peripheral vascular health is commonly assessed through the use of angiograms, which are serially captured individual X-ray images of blood vessels that show blood flow through arteries. A contrast dye is injected into the blood to cause the blood vessels to appear more clearly in the image. Vessels appear dark against a lighter background in the acquired image wherever blood flows. The resulting images are both low resolution and low in luminance contrast differentiation.

Angiograms may also be the first step of a procedure to find and fix a blood vessel blockage, aneurysm, structural heart issue, or valve disease. Blood flow can be impeded by the presence of vessel tortuosity or the presence of plaque within the vessel, causing a reduction of vessel lumen diameter or complete blockage of the vessel.

### SUMMARY

The algorithms disclosed herein are based on the observation that the directionality of information at each point in the image is based on the magnitude, rate of change, and/or the direction of the local brightness gradient. Thus, the algorithms disclosed herein are based on the determination of gradient (contour) distancing with transform and blurring and the use of a gradient edge operator.

In an aspect of the present disclosure, a method for visualizing luminance variance for an object may include receiving image data associated with a digital image of the object. An algorithm is applied to the image data to generate an enhanced image. The enhanced image includes connected pixel value lines representative of pixel value ranges from the input image to enable visualization of luminance variance of the object by the human eye and/or optimized as more highly structured image data for improved machine learning/artificial intelligence performance.

In another aspect of the present disclosure, a method for visualizing changes in an object may include receiving image data comprising one or more frames including a digital input image of the object. A smoothing function is applied to the image data to obtain a smoothed image. A non-linear transfer function is applied to the smoothed image to obtain changes in values of a selected image-related parameter associated with the input image. A bi-directional derivative operator is applied to the changes to obtain an enhanced image, in which a magnitude of the image-related parameter of pixels is mapped to a grayscale or a color palette. The enhanced image includes connected pixel value lines.

In a further aspect of the present disclosure, a method of imaging vasculature in a body tissue may include receiving image data comprising one or more frames including a digital input image of the body tissue. An algorithm is applied to the image data to generate an enhanced image. The enhanced image includes connected pixel value lines representative of pixel value ranges from the input image to enable visualization of a fluid flow-related parameter associated with the body tissue by the human eye or AI analytics.

The present technology offers visualization of structural patterns in solid, or patterns of flow in liquid and/or gaseous objects by geometric mapping of variances in grayscale images of such objects.

In the field of medicine, the technology offers new opportunities for early detection and risk assessments and helps physicians select the best treatment for their patients by non-invasively measuring gradient flow using a single image or a series of images. The technology processes existing images such as angiograms (i.e., X-rays), CT scans, and heart ultrasound images, as well as other types of medical images. Consequently, it is non-invasive, near real-time, and does not require additional table time or radiation. The technology is utilized “Non-Invasively” (you do not need to go into the body), therefore, Morbidity and Mortality (M&M's) or procedural risk factors/clinical outcomes are significantly improved. Some of the advantages of the presently disclosed technology are that it is: Software-based; Non-invasive—safer for patients; provides instant feedback; Supports decision-making; provides Shortened “table” time; is not limited to cardiology (e.g., can be used for imaging Brain, Carotid, Limbs, Lung, Kidney, etc.); can provide mapping of fluid flow, can provide ability to Monitor changes over time and provides higher throughput for users.

Additional features and advantages of the subject technology will be set forth in the description below and in part, will be apparent from the description, or may be learned by practice of the subject technology. The advantages of the subject technology will be realized and attained by the structure, particularly pointed out in the written description and embodiments hereof, as well as the appended drawings.

It is to be understood that both the foregoing general description and the following detailed description are exemplary and explanatory and are intended to provide further explanation of the subject technology.

### BRIEF DESCRIPTION OF THE DRAWINGS

Various features of illustrative embodiments of the inventions are described below with reference to the drawings. The illustrated embodiments are intended to illustrate, but not to limit, the inventions. The drawings contain the following figures:

FIG. 1 shows a single frame image acquired from X-ray fluoroscopy video sequence following a contrast injection.

FIG. 2 shows an image of a wire that inserted in a patient's artery through a catheter during a Fractional Flow Reserve (FFR) procedure.

FIG. 3 shows an Angiogram with contrast and the presence of FFR wire pushed to the distal position of stenosis (arrow).

FIG. 4 shows an example of the enhancement obtained from post-processing an angiogram using one implementation of the algorithm disclosed herein.

FIG. 5 is another example of the enhanced visualization obtained from post-processing using one implementation of the algorithm disclosed herein.

FIG. 6 shows yet another example of the enhanced visualization obtained from post-processing using one implementation of the algorithm disclosed herein.

FIG. 7 shows a post-processed image using one implementation of the grayscale post-processing algorithm disclosed herein.

FIG. 8 shows a post-processed image using one implementation of the color post-processing algorithm disclosed herein.

FIG. 9 shows the post-processed image using one implementation of the grayscale post-processing algorithm performed on the same original angiogram shown in FIG. 8.

FIG. 10 shows an example of a system utilizing the technology disclosed herein for enhanced visualization of angiograms.

FIG. 11 shows a comparison between a conventionally used workflow of analyzing angiography images and an example workflow utilizing the technology disclosed herein for enhancing the visualization of angiography images.

FIG. 12 shows a flow chart illustrating a method for creating a digital visualization from a grayscale or color original image, in accordance with one implementation of the algorithms disclosed in the present disclosure.

FIGS. 12a-12m are images resulting from various processing steps of the method illustrated in FIG. 12. FIG. 12aa shows the color depth for the original image in FIG. 12. FIG. 12cc shows the color depth for the image in FIG. 12c; FIG. 12ee shows the color depth for the image in FIG. 12e; and FIG. 12mm shows the color depth for the image in FIG. 12m.

FIG. 13 shows a flow chart illustrating another method for creating a digital visualization from a grayscale or color original image, in accordance with one implementation of the algorithms disclosed in the present disclosure.

FIGS. 13a-13i are images resulting from various processing steps of the method illustrated in FIG. 13. FIG. 13aa shows the color depth for the image in FIG. 13. FIG. 13cc shows the color depth for the image in FIG. 13c; FIG. 13ee shows the color depth for the image in FIG. 13e; FIG. 13hh shows the color depth for the image in FIG. 13h; and FIG. 13ii shows the color depth for the image in FIG. 13ii;

FIG. 14 shows a high level workflow for performing vessel centerline detection and measurement as well as cross-section measurements, in accordance with one implementation of the technology disclosed herein.

FIGS. 14a-14h are images resulting from various processing steps of the process illustrated in FIG. 14.

FIG. 15 is an example of a clinically obtained X-ray Angiography image and a sample analysis of the range of pixel values contained in them. The full image is shown on the left divided into 64 sub-images (256×256). Panel b shows a histogram of the entire image shown on the left. Panel c shows two histograms from two regions which contain brighter areas in the image shown on the left. Panel d shows two histograms from two regions which contain the darker area of the image shown on the left.

FIG. 16 is example of another clinically obtained X-ray Angiography image and a sample analysis of the range of pixel values contained in them. The full image is shown on the left divided into 64 sub-images (256×256). Panel b shows a histogram of the entire image shown on the left. Panel c shows three histograms from two regions which contain brighter areas in the image shown on the left. Panel d shows three histograms from regions which contain the darker area in the image on the left.

FIG. 17 shows examples of sub-images, including corresponding mean value and standard deviation of luminance values, obtained from the clinically obtained X-ray Angiography image shown in FIG. 16.

FIG. 18 shows the distribution of each of these 11 full tissue groups contained in the digital phantom images.

FIG. 19 shows just three examples of the vessel sub-images and cross-sections used to develop the digital phantom. Panels (a)-(c) show three different vessel segments. Panels (d)-(f) show the corresponding cross-sections extracted from the sub-image in blue and the fit polynomial in red.

FIG. 20 shows four example sub-images, including these test targets from the digital phantom. Panels (a)-(d) show four different vessel segments. Panels (e)-(h) show corresponding cross-sections extracted from the sub-image in blue and the fit polynomial as the dashed curve.

FIG. 21 shows an example of one of the phantom test images.

FIG. 22 shows four example sub-images, including these test targets from the digital phantom. Panels (a)-(c) show four different vessel segments. Panels (d)-(f) show corresponding cross-sections extracted from the sub-image in blue and the fit polynomial as the dashed curve. FIG. 23 shows an example of a histogram h(n) and cumulative distribution P(n) used in the Image Contrast calculation described herein.

FIG. 24A is an example of a phantom test image.

FIG. 24B is an example of an output image of the color algorithm as applied to the phantom image of FIG. 24A, in accordance with one implementation of the present disclosure.

FIG. 24C is an example of an output image of the grayscale algorithm as applied to the phantom image of FIG. 24A, in accordance with one implementation of the present disclosure.

FIG. 25 shows an example set of input and output sub-images for a phantom target. Panel a is the original (input) sub-image, panel b is the output sub-image of the color algorithm as applied to the input sub-image of panel a, panel c is the output sub-image of the grayscale algorithm as applied to the input sub-image of panel a, and panels d-f are corresponding histograms.

FIG. 26 shows another example set of input and output sub-images for a phantom target. Panel a is the original (input) sub-image, panel b is the output sub-image of the color algorithm as applied to the input sub-image of panel a, panel c is the output sub-image of the grayscale algorithm as applied to the input sub-image of panel a, and panels d-f are corresponding histograms.

FIG. 27 illustrates vessel segment selection using one implementation of the algorithms disclosed herein. Panels a-c show three vessel areas selected from one clinically obtained image. Panels d-f show corresponding vessel segments after a rotation process. Panels g-i show the corresponding cross-sections for the average of vessel segments along the red lines in vessel segments shown in panels d-f.

FIG. 28A shows a sample input Angiogram.

FIG. 28B shows an enhanced output image after the application of the color algorithm in accordance with one implementation of the present disclosure.

FIG. 28C shows an enhanced output image after application of the grayscale algorithm in accordance with one implementation of the present disclosure.

FIG. 29 shows an example of input and output images for a vessel segment the after application of the algorithms in accordance with one implementation of the present disclosure. Panel a is a sub-image of a vessel segment in the original image. Panel b is the output image after the application of the color algorithm to the vessel segment in panel a, in accordance with one implementation of the present disclosure. Panel c is the output image after the application of the grayscale algorithm to the vessel segment in panel a, in accordance with one implementation of the present disclosure. Panels g-i show corresponding cross-sections.

FIG. 30 shows another example of input and output images for a vessel segment after the application of the algorithms in accordance with one implementation of the present disclosure. Panel a is a sub-image of a vessel segment in the original image. Panel b is the output image after the application of the color algorithm to the vessel segment in panel a, in accordance with one implementation of the present disclosure. Panel c is the output image after the application of the grayscale algorithm to the vessel segment in panel a, in accordance with one implementation of the present disclosure. Panels g-i show corresponding cross-sections.

FIG. 31A shows a test input image containing a linear grayscale gradient (left) and the two outputs, generated using the color and the grayscale algorithms according to one implementation of the present disclosure, displayed alongside it.

FIG. 31B shows another test input image containing a linear grayscale gradient (left) and the two outputs, generated using the color and the grayscale algorithms according to one implementation of the present disclosure, displayed alongside it.

### DETAILED DESCRIPTION

It is understood that various configurations of the subject technology will become readily apparent to those skilled in the art from the disclosure, wherein various configurations of the subject technology are shown and described by way of illustration. As will be realized, the subject technology is capable of other and different configurations, and its several details are capable of modification in various other respects, all without departing from the scope of the subject technology. Accordingly, the summary, drawings, and detailed description are to be regarded as illustrative in nature and not as restrictive.

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be apparent to those skilled in the art that the subject technology may be practiced without these specific details. In some instances, well-known structures and components are shown in block diagram form in order to avoid obscuring the concepts of the subject technology. Like components are labeled with identical element numbers for ease of understanding.

The technology disclosed herein provides for visualization and characterization of patterns of flow around solid structures and/or flow in liquid and/or gaseous objects based on one or a series of grayscale images. For example, the technology disclosed herein provides for visualization and characterization of vascular structures and the fluid flow within vessels or the heart chambers non-invasively and in real-time. By providing such visualization, the technology disclosed herein addresses significant barriers in cardiovascular medicine for clinicians to “see” the disease in its manifestations.

Those skilled in the art would appreciate that while the description that follows focuses on the visualization of features in medical images, the technology is generally applicable to images of objects (solid, liquid and/or gaseous) where geometric mapping of variances can reveal solid structural patterns as well as flow patterns. Examples of other applications of the disclosed technology include, but are not limited to, visualizing flow patterns in: images of aerodynamic objects in motion, astronomical images, images of pipelines, images of electrical transmission lines, and the like.

The technology is intended for post-processing digital images (e.g., digital medical images) which may be grayscale or colored in ways that present enhanced visualization(s) of the pixel information in an original acquired image, such as an angiogram, resulting in greater visibility of essential characteristics within the newly generated images. The term “enhanced” as used herein refers to an improvement resulting in moving an aspect in the image that was under a “just noticeable difference” threshold to the human eye in an original image, to above that threshold in the enhanced image. The term “enhanced” may also refer to an improvement resulting in moving an aspect in the image that was under a “just noticeable difference” threshold to an artificial intelligence and/or a machine learning processor in an original image, to above that threshold in the enhanced image. The enhanced visualizations vary by application in numbers and types of algorithmic processing. Within each application, the resulting visualizations that allow clinicians to see more of—and more clearly—the tissue patterns that are clinically diagnostic/relevant to the understanding of an individual's specific state of health. These patterns are already present in the original acquired image, but they are not readily discernible by the human vision system. This is due to the known inherent limitations of, e.g., grayscale images such as digital medical images, which vary by acquired source, and which this technology is intended to overcome.

The primary visual cortex in the brain contains neurons that respond to different orientations of edges, such as horizontal, vertical, or diagonal. This edge detection relies on having abrupt changes in luminance or color among neighboring pixels in an image.

To provide images with detectable contrast from the minimally varying gray levels from within the contrast dye in vessels, the image processing algorithm applies a sequence of functions that quantizes shades of gray to display discrete color lines (edges), each of which are mapped to specific luminance values within a digital image.

To this end, connected pixel values (also referred to herein as CPV, or iso-luminance) lines are created from grayscale luminance values. Grayscale luminance values are mapped to color values. In the example provided in Table A, original luminance values in an 8-bit image are in the left column. The color replacement in RGB values is shown in the second column. These relationships remain constant regardless of the type of image data.

TABLE A
Grayscale luminance values and correlative RGB color values

| | |
|---|---|
| 90 | (130,103,078) |
| 90 | (130,078,103) |
| 89 | (130,07 [symbol] ,018) |
| 88 | (130,108,074) |
| 87 | (130,103,072) |
| 87 | (130,072,072) |
| 8 [symbol] | (148,070,070) |
| 8 [symbol] | (130,070,070) |
| 8 [symbol] | (103,070,070) |
| 8 [symbol] | (148,103,0 [symbol] ) |
| 85 | (130,103,088) |
| 86 | (103,088,088) |
| 84 | (130,103,088) |
| 82 | (130,069,103) |
| 81 | (130,061,108) |
| 81 | (103,108,061) |
| 80 | (103,103,059) |

[symbol]

indicates data missing or illegible when filed

The CPV lines are lines displayed in the enhanced images that connect neighboring areas that have similar pixel values. The CPV lines, therefore, geometrically delineate neighborhoods of common pixel values, and by doing this, the CPV lines highlight the location of the contrast dye in the original image and the existing geometry present in the vessel structure The resulting enhancement provides increased visibility of changes in structures that were not easily visible within the original image, as measured by increased contrast and sharpness, allowing the physician to see more of the structure and content of the vessels.

In the context of angiographic image enhancement, CPV lines improve the visual quality of the images and provide additional visual information that a reader can use along with the original angiogram to provide appropriate management for patients with vascular disorders. The CPV lines can vary based on the original image pixel values in the x and y directions. Since the CPV lines represent similar pixel values, changes from one CPV line to another visually display a variance or progression from one area to another. How quickly or gradually the CPV lines change (i.e., gap between lines) and in which direction indicates how quickly and in which direction the grayscale values change.

The colors or shades of gray of the CPV lines were chosen to optimize the visual information to the human vision system, but the specific color or shade of gray of each CPV line represents the relative position of the neighborhood of grayscale pixel values within the range of input values.

The mapping is non-linear. Because the preponderance of vessel luminance values is dark, the algorithm can assign more colors to areas in lower luminance values in the image. Adjustments can be made to the algorithm to also assign more colors or grayscale values in the output image for medium gray or bright pixel values.

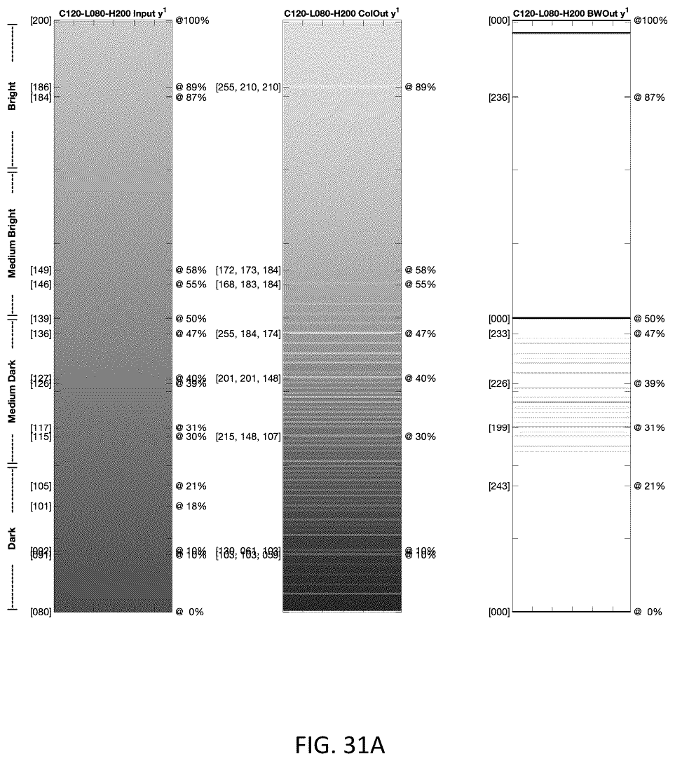

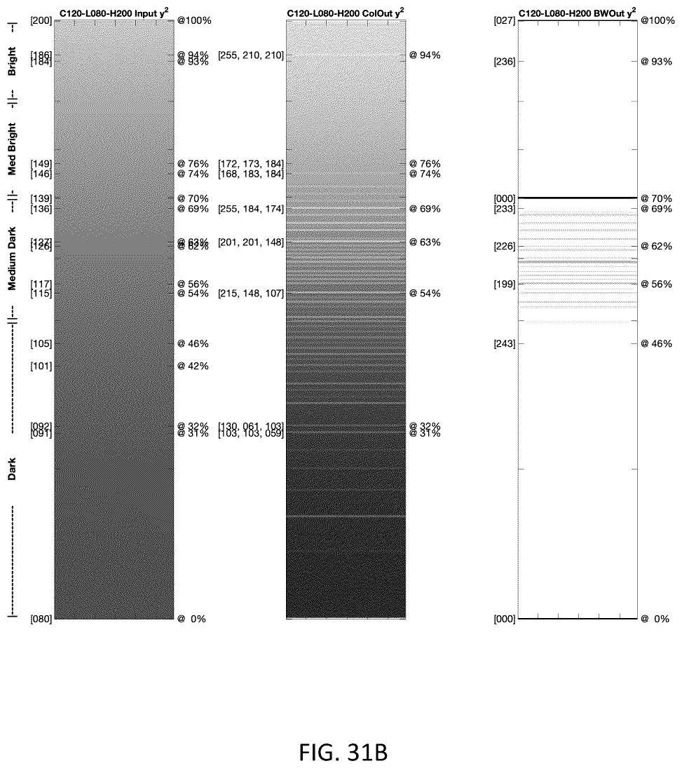

The CPV values have intervals between them to improve the visualization of gradients. By having separations of luminance values between lines, gradients become visible in the processed images. The examples shown in FIGS. 31A and 31B contain two grayscale bars (leftmost panels in each of the figures), each with grayscale values changing from black to light gray, but with differing gradients. The middle panel in each figure is the result of processing the grayscale bars using the color algorithm disclosed herein. The separation between the color lines in the middle panels reflects the algorithmic design for optimizing differences that lie in the gray values of grayscale images, e.g., angiographic images, infused with contrast dye.

Human vision is designed to easily see and interpret intervals of patterns. Human vision is not concerned with the color of the line segments but with their length and distances between adjacent lines. A unique property of the resulting gradient-based contour mapping is that the edges express variances (gradients) based on luminance changes. The faster the change in luminance values, the closer the resulting contour lines become. Those of skill in the art, upon understanding of this disclosure, would appreciate that while the present disclosure utilizes luminance as the image parameter for processing and enhancement of the images, other parameters such as, for example, entropy, pixel density, etc., may also be suitably used for similar applications.

Gradients in data image representation provide valuable information about the rate of change of pixel values across an image. Gradients in the color algorithm disclosed herein, for example, are computed using, for example, the Sobel operator. However, the algorithm is not limited to such an operator. Those of skill in the art, upon understanding the present disclosure, will be able to suitably select a desired operator for the specific purpose for which the algorithm is being applied. Representation of gradients in data image as provided herein enables:
(a) Edge Detection: Gradients are widely used for edge detection in image processing. An edge represents a significant change in intensity or color in an image. By analyzing the magnitude and direction of gradients, edges can be identified. Edge detection is crucial in various applications, such as feature extraction.
(b) Feature Extraction: Gradients can capture important features in an image. By examining the gradient magnitude and orientation, specific patterns or structures can be identified. These features can be used to characterize objects or regions in image analysis tasks like object detection, texture analysis, or image classification.
(c) Image Enhancement: Gradients can be employed in image enhancement techniques to improve the overall visual quality or highlight specific structures. For example, gradient-based methods like contrast stretching can be used to enhance local contrast and improve the overall appearance of an image.
(d) Shape Analysis: Gradients are valuable in shape analysis and object recognition tasks. By examining the orientation and magnitude of gradients, the contours and shapes of objects can be analyzed. Shape descriptors can be derived from gradient information, allowing for object matching, shape classification, or deformable object tracking.

In one implementation of the algorithm described herein, the largest number of values are mapped within the darker grayscale values in the original image. In applications such as enhancement of angiography images, mapping of the lines below the bright areas of the image reduces clutter from areas outside of the vessels in the image. This helps bring attention to the vessels themselves, which is one of the most important parts of the assessment of the angiographic images.

On the other hand, the Grayscale Algorithm disclosed herein provides for an increase in contrast and sharpness while simplifying the information in the image. By doing so, it helps delineate the margins of vessels more clearly in angiograms. The Grayscale Algorithm is designed to focus the visualization on the vessel margin structures by displaying CPV lines for only the medium dark grayscale value neighborhoods in the input image, but not the darkest grayscale values (the contrast material in the blood), as shown in the rightmost panel in FIG. 31A. By design, there are fewer CPV lines in the grayscale algorithm in the darkest part of the image, which is typically the content inside the vessel.

Thus, the CPV lines generated using the algorithm described herein help visually display increased contrast and sharpness and provide better visualization of subtle changes in the input image. Increasing sharpness and contrast helps to bring out the fine details and edges of objects or areas in the image, making the boundaries between different elements more distinct, and resulting in a clearer presentation of the captured information.

The enhanced Color Algorithm enhances the visualization of the contrast dye within the lumen of the vessels by increasing the visibility of changes in the vessel structure and content that are not easily visible within the original image, allowing the physician to see what is happening inside the vessel more clearly.

The colors chosen for CPV lines can be selected to optimize the visual information, and help delineate neighborhoods of common grayscale pixel values, making the existing geometry present in the vessel more visible than in the original image. The increased contrast allows for better differentiation between the vessels and the surrounding tissues. Resulting in greater visualization of structural characteristics within the original images.

On the other hand, the Grayscale Algorithm is focused on the walls of the vessel, delineating the margins of vessel wall edges more clearly, revealing greater detail at the edge of the vessel. Highlighting the vessel wall allows the vessel wall to be more clearly defined. Therefore, there is better visualization of the walls without having the visualization of the variance of the contrast dye as part of the image.

The technology disclosed herein is based on non-invasive algorithmic processing and does not require changing the imaging acquisition infrastructure used to acquire the original digital image. It requires only the original acquired image(s) without the need to acquire additional source images, intervene medically, or engage in other ancillary procedures. Each acquired image can be serially post-processed algorithmically and displayed within seconds. This means that the technology can be used for in vivo single-image as well as multi-frame video sequence processing, for example, during an angiographic procedure in a cath lab.

Deformation of blood vessels is one of the key factors contributing to vascular and heart disease. Analysis of heart and peripheral vascular health is commonly assessed through the use of angiograms. An angiogram is a scan that shows blood flow through arteries using X-rays. Blood vessels appear in the image after a contrast dye is injected into the blood. Vessels appear dark against lighter background in the acquired image wherever it flows. Angiograms may be the first step of a procedure to find and fix a blood vessel blockage, aneurysm, structural heart, or valve disease, etc.

Blood flow can be impeded by the presence of vessel tortuosity, total blockage of the vessel, and the presence of plaque within the vessel, causing a reduction of vessel lumen diameter.

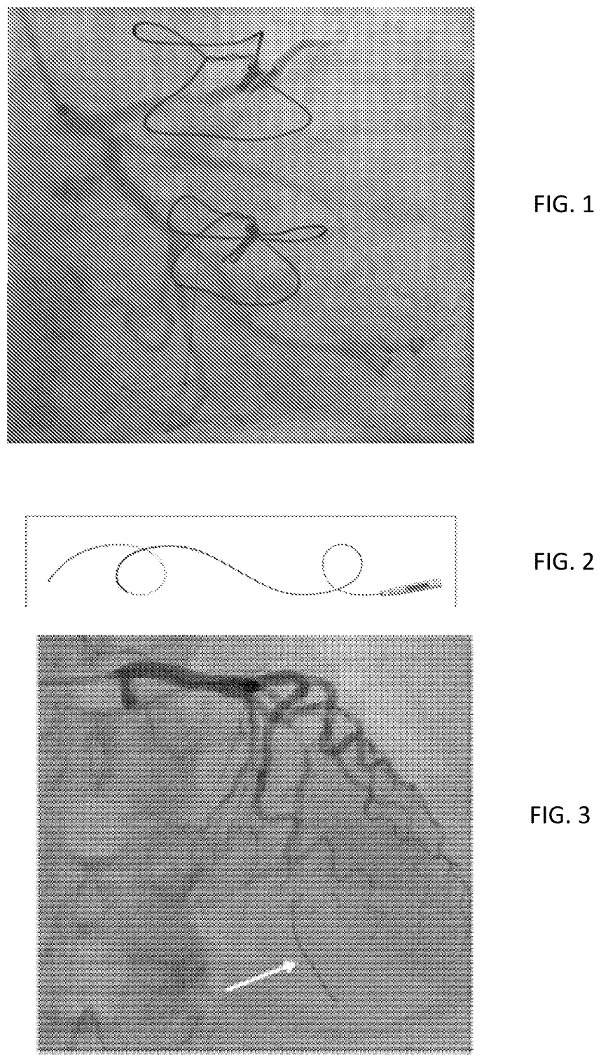

FIG. 1, which shows a single frame image acquired from an X-ray fluoroscopy video sequence following a contrast injection, illustrates some of the challenges associated with heart and peripheral vascular health assessment. Factors such as blood viscosity, vessel wall structures, the geometry of the vascular system, and its changes from systole to diastole phases, and the geometry of the vessels themselves cannot be discerned from such a single frame image. In addition, the X-rays must pass through different tissues of the body leading to variations of luminance and contrast both within and between exposed frames of video frames in the acquired image. Further, the presence of external structures (e.g., sutures) in the image may also block critical areas of the angiogram where stenosis of the vessel may have occurred.

Once a potential blockage or area of stenosis in the X-ray image is assessed by the cardiologist, the percentage of the blockage needs to be assessed. Currently, the gold standard for quantifying the amount of blockage is Fractional Flow Reserve (FFR), which is a commonly used technique in coronary catheterization to measure pressure differences across coronary artery stenosis (narrowing, usually due to atherosclerosis) so as to detect the likelihood that the stenosis impedes oxygen delivery to the heart muscle (myocardial ischemia) and whether further treatment like coronary angioplasty or Coronary Artery Bypass Graft (CABG) surgery is necessary.

The FFR procedure involves inserting a wire into a patient's arteries through a catheter, such as the one shown in FIG. 2. The tip of the wire measures flow. Measurements are taken before and beyond the observed potential blockage of the vessel.

FFR measurements must be obtained during a period of maximal blood flow or maximal hyperemia. To achieve maximal hyperemia, a hyperemic stimulus is administered either intravenously or intracoronary through the guide catheter. The patient remains on the table and the clinical staff then waits up to 10 minutes for the stimulant to take full effect.

FFR results are calculated using a pressure ratio of pressure measured distal to the blockage (Pd) and pressure proximal to the blockage (Pa). FIG. 3 shows an Angiogram with contrast and the presence of FFR wire pushed to the distal position of stenosis (shown by the arrow).

Interpretation of possible stenosis is based on a ratio based on pressure differences. In the FFR process, no new visual information is provided to the cardiologist for lesion assessment including the actual diameter and length of the stenosis, the presence of plaque, or flow before, within, or beyond the area of concern. The algorithmic sequences disclosed herein can be employed in near real-time in cath labs, provide new visual perspective on the vasculature, are non-invasive, and do not require administration of any drug into the patient to induce hyperemia.

Visualizing the flow patterns in the cardiovascular and peripheral vascular system is challenging because the underlying fluid dynamics involves the calculation of various properties of the fluid, such as flow velocity, pressure, density, and temperature. The measurements needed to simulate the interaction of liquids and gases are so computationally expensive that high-speed supercomputers are required for implementing such simulations. Consequently, real-time calculations for clinical environments are not viable.

As a result, there is no known visualization technology available for real-time visualization and characterization of blood flow in angiographic images in clinical settings.

Plaque and stenotic lesions in arteries can, therefore, be missed by clinicians due to inability to see fine details in the angiograms.

One of the applications of the presently disclosed technology is to aid physicians in their clinical review and analysis of coronary angiograms by providing enhanced visualizations that help reveal more details (e.g., variance, directionality, etc.), more clearly, about the clinically relevant characteristics of the coronary vessels.

The technology disclosed herein provides for enhanced visualization of characteristics of vessel walls, internal and external, and associated intricate structures, to the interpreting physician to support the clinical management of coronary artery disease (CAD). The contrast and intensity of the walls of the vessels can be far more clearly differentiated.

Visualization of the fluid mechanical environment in an individual's cardiovascular system can contribute to the understanding of its vascular morphologies and the presence of potential structural heart malformations. Circumferential, axial, and radial stresses on vessel walls change throughout the cardiac cycle. While the effects of these stresses have been extensively investigated and calculated mathematically, it can be helpful to the attending cardiologist or thoracic surgeon to be able to immediately observe, visual changes in vascular flow and their impact on the patient's vessel walls.

To support a clinician's assessment of fluid dynamics, the technology disclosed herein visualizes and maps localized boundary conditions as contours of fluid-based luminance values in fluoroscopic images. Much like the isometric contours of elevations on maps, bathymetric depths in ocean charts, or isobars on weather maps, the contour lines inside vessel walls, generated based on the algorithmic post-processing, in the angiogram's circumscribed boundaries that are statistically related among similar ranges of fluid contrast density.

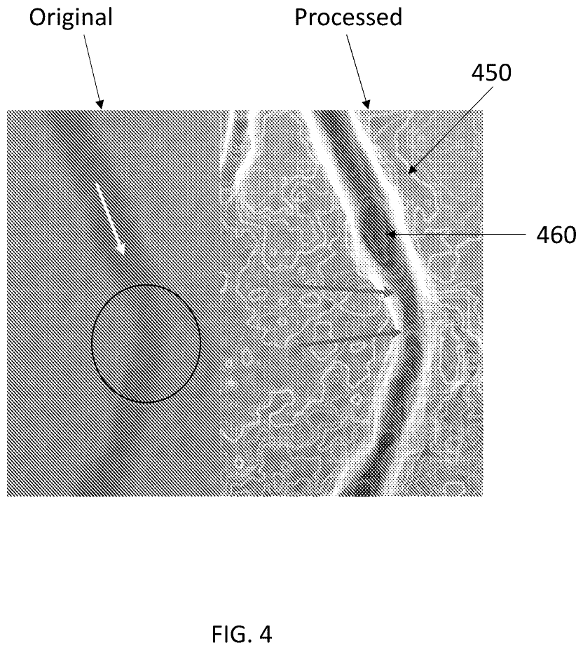

FIG. 4 shows an example of the enhancement obtained from post-processing an angiogram using the algorithms disclosed herein. The Original angiogram is on the left. The post-processed image is on right, showing contours 450 of flow and vessel walls. The area of stenosis is circled in the original image. White arrow in the original indicates direction of flow within the artery. Arrows in the post-processed image point to points of change in contour margins from concave to convex in the direction of flow. A unique property of the contours 450 is their change in the direction of fluid flow from concave at the start of stenosis (upper arrow in the post-processed image) to convex and the end of the stenosis (lower arrow in the post-processed image). Advantageously, this geometric approach reveals complex interactions of tissues and fluids with minimal computation requirements. The output of the images is also easily interpreted by clinicians because the images reflect patterns, e.g., feature 460, already understood by clinicians and used routinely cardiology.

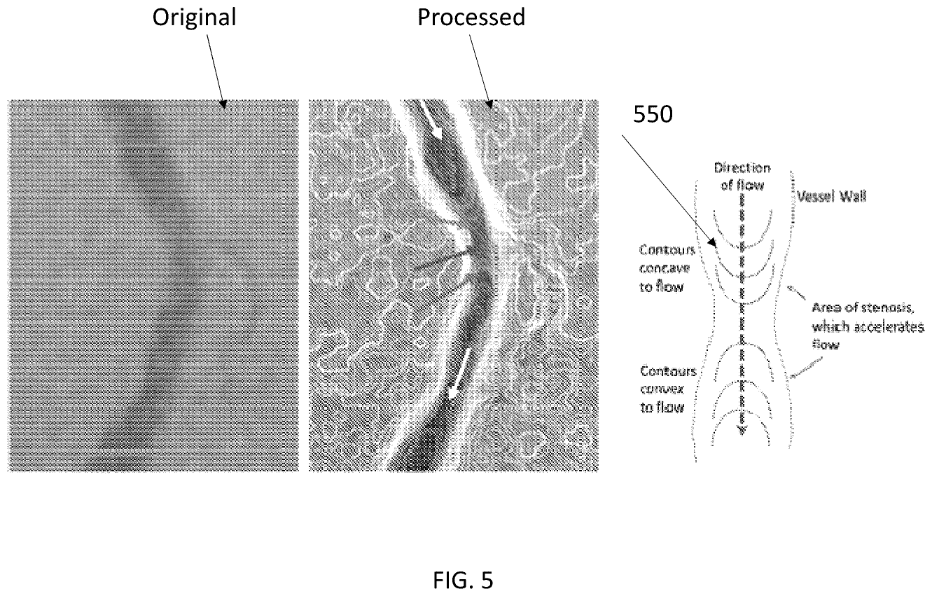

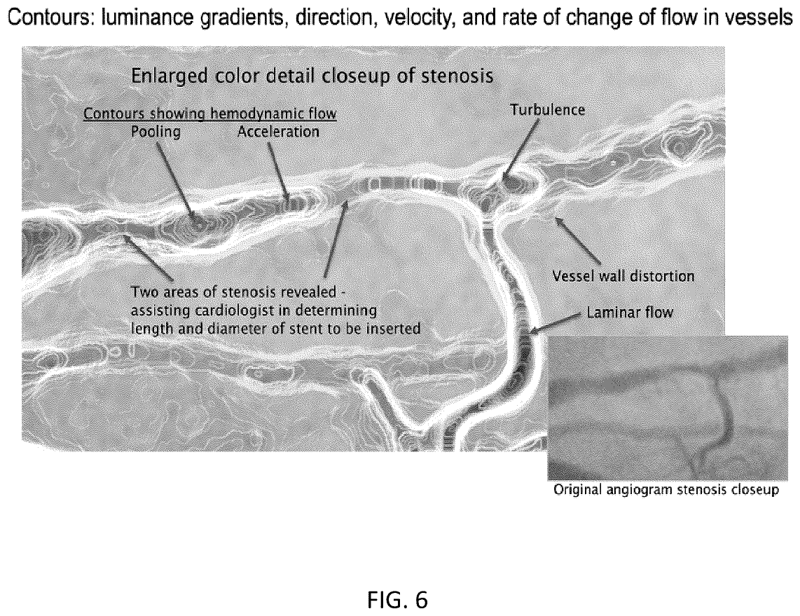

FIG. 5 is another example of the enhanced visualization obtained from post-processing using algorithms disclosed herein. The original angiogram is in the left panel, and the algorithmically post-processed image in center panel, showing contours of flow and vessel walls. Area of concern is marked between the lines in the original angiogram. In the post-processed image, the arrows point to change in the leading edge of contour margin shapes, from concave—proximal to minimum lumen diameter—to convex—distal to stenosis in direction of flow. The middle arrow indicates area of minimum lumen diameter. The white arrows indicate direction of flow within the vessel. The far right panel graphically illustrates changes in contours 550 from concave to convex in area of stenosis. A unique property of the contours is their change in fluid flow from concave at the start of stenosis (center panel, top arrow) to convex at the end of the stenosis (center panel, bottom arrow), in the middle panel.

FIG. 6 shows yet another example of the enhanced visualization obtained from post-processing using algorithms disclosed herein. The original grayscale angiogram is in the lower right inset. The instantaneous velocity map revealed by the visualization shown in the image indicates hemodynamic flow parameters, e.g., pooling, acceleration, turbulence, etc.

FIG. 6 shows two areas of stenosis, one of which could not be seen in the original. Pooling is indicated prior to the second stenotic lesion. To the right of the pooling, the contours become elongated prior to entering the narrow area of the artery where the blood is greatly accelerated. The output of the stenosis is higher than a Reynolds number of 2000 and turbulence occurs. The impact of the turbulence can be seen at the bifurcation with a high wall shear stress component distorting the vessel walls. While all this information is visualizable from a single frame of a video, additional flow information as a function of time can be obtained by using a sequence of still images post-processed using the algorithms disclosed herein.

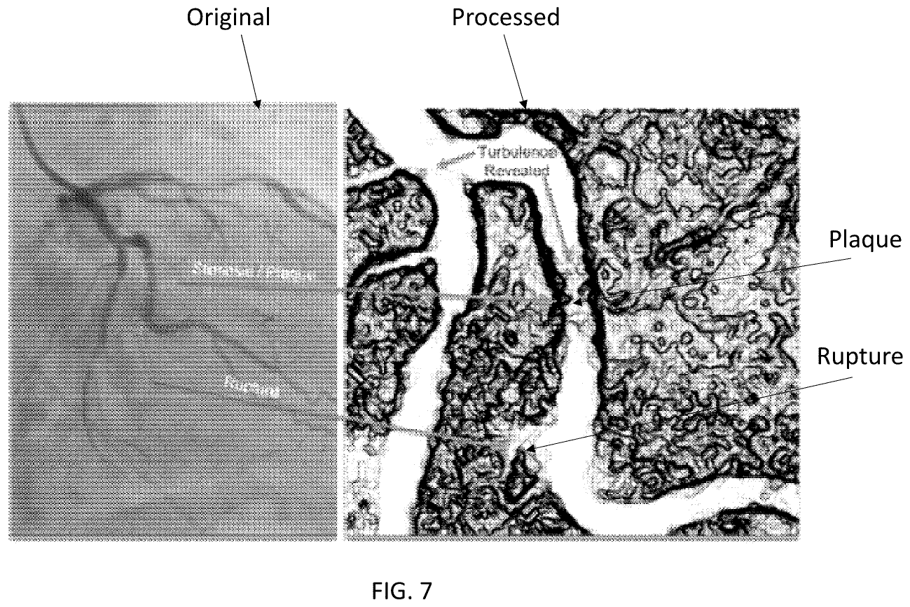

As yet another example, FIG. 7 shows a post-processed image using a grayscale post-processing algorithm disclosed herein. The original angiogram is in the left panel. The plaque and vessel rupture are shown in the circumflex artery, visible in the right panel (showing the post-processed image) cannot be seen in the original angiogram.

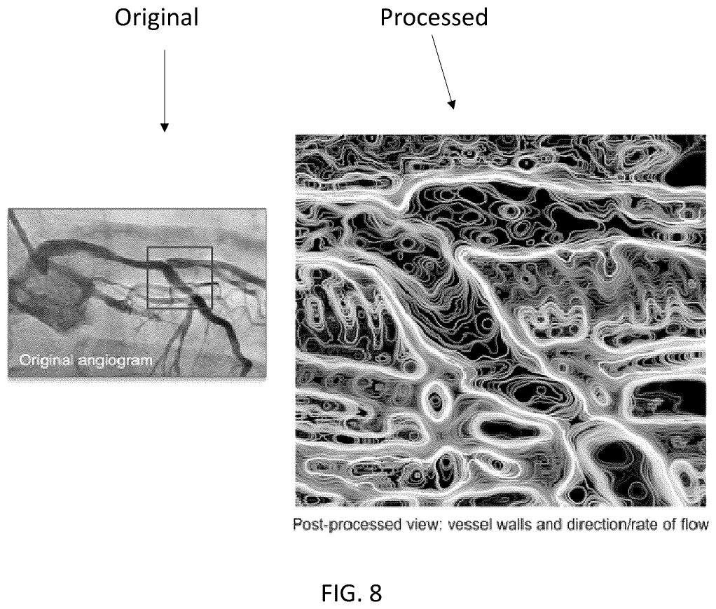

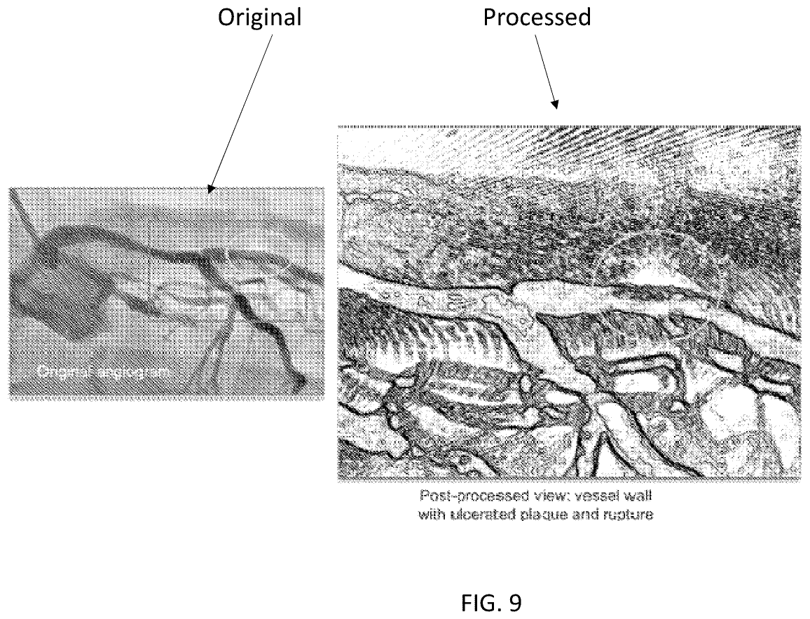

FIG. 8 is an example of a post-processed image using a color post-processing algorithm disclosed herein. The original angiogram is in the left panel. The flow patterns revealed in the color post-processed image in the right panel are not visualizable in the original angiogram. FIG. 9 shows the post-processed image using the grayscale post-processing algorithm performed on the same original angiogram shown in FIG. 8. The grayscale version reveals ulcerated plaque and vessel rupture with bleeding as indicated by the circumscribed portion, and not visible in the original.

The algorithmically generated contour boundary lines correlate with and display identifiably distinct information (e.g., the ulcerated plaque and vessel rupture seen in FIGS. 7 and 9, or the changes in flow contours seen in FIG. 5) in visible patterns: (a) The distribution of fluid densities within the vascular space; (b) The patterns and directions of flow within a given region of the vasculature at any given point; (c) Changes in rate and nature of flow as blood pools before stenosis, moves through restricted regions of the vessel or becomes turbulent distal to stenosis or at points of vascular bifurcations; and (d) Changes from laminar to turbulent, pooling, accelerating, decelerating, and tortuous flow are visibly revealed.

One of the intents of this post-processing technology is to allow the interventionalist to see the patterns of vessel wall abnormalities more clearly, such as stenosis, in one or more areas of the arteries, and to reveal them more consistently and comprehensively by visualizing characteristics of differing types of clinically relevant blood flow patterns, such as pooling, turbulence, and directionality. The assessment by the interventionalist is made in real-time to determine if treatment is necessary, and if so, what treatment and where.

The post-processing image-based technology disclosed herein is designed to assist clinicians in near real-time as they review angiogram images for possible disease. The technology provides processing of captured images, allowing enhanced visualization of characteristics within the images that the human vision system can then discern. This is designed to optimize the contrast resolution of the original image for optimal differentiation by the human vision system. As a result, the structures of clinical relevance that clinicians are trained to look for become easier to see. This includes vascular properties such as wall structure integrity, blockage, or reduction in vessel lumen diameter.

While the technology is widely applicable to any image of objects comprising flow or structural patterns, the disclosure that follows explains the algorithms in the context of enhancing the visualization of information in X-ray angiograms as an example. As discussed elsewhere herein, those of skill in the art, upon understanding the present disclosure, would be able to adapt the algorithms disclosed herein to other types of images.

The algorithms disclosed herein are based on the observation that the directionality of information at each point in the image is based on the magnitude and/or the direction of the local brightness gradient. Thus, the algorithms disclosed herein are based on the determination of gradient (contour) distancing with transform and blurring and the use of a gradient edge operator.

In the context of enhancing an angiogram, an example implementation of the post-processing of a grayscale image, therefore, begins by applying a transform that darkens the contrast within the original angiogram while brightening the surrounding heart tissue for better edge differentiation of the vessels. The applied transform is variable and can be adjusted based on imaging modality, tissue types, and desired visual output.

Next, a blurring function is applied. The blurring function, in some embodiments, may include various convolutions. While the disclosure that follows uses a median filter, other filters may be utilized based on the context. The higher the blurring factor, the greater the distance between contours and the lower the ambient noise in the resulting image.

This is followed by the application of a bi-directional derivative of a gradient edge operator. The operator is applied in both horizontal and vertical directions, thereby making the operator insensitive to or biased to the orientation of edges.

The intent of the sequencing is to have the edges express variances based on brightness changes. The faster the change in luminance values, the closer the resulting contour lines become.

In color post-processing algorithms, color vectors are mapped by a transform following the blurring factor and indicate magnitude of luminance variance in the image. The false-color scale of the color contours is based on thresholds based on the magnitude of vectors and is independent of direction. The false-color scale is not limited to any particular combination of colors. For example, in some embodiments, the false-color scale may be based on the Red-Green-Blue (RGB) color scale. Other color schemes may be used depending on the context and application without deviating from the principles of the presently disclosed algorithms.

While the visualizations represented in this document were derived using 3×3 derivative kernels, other bases for kernels can be employed such as 5×5, 7×7, or non-symmetrical configurations. For example, while a 5×5 kernel requires more processing time, it can provide more smoothly varying patterns, less noise, and more isotopically uniform results.

The filter can be applied on grayscale image data, or independently on R, G, and B channels (or any other color channels used depending on the particular implementation).

Binning counts can be employed to minimize spikes in the characterizations of tissues and fluid. Laplacian Operator can also be applied to the sequence. Not shown here.

Assuming a grayscale range of 8 bits (0-255 luminance pixel values), then each step in the grayscale representation of the contours=1.4 degrees in vector direction.

Thus, in the context of enhancing medical images such as angiograms, the grayscale algorithm reveals fine details of the vascular structure, while the color algorithm reveals hemodynamic flow patterns. Details of the vascular structure point to variance in flow, while the contours resulting from the color algorithm indicate both fluid flows and areas of possible blockage.

The disclosure that follows provides further details of the algorithms on which the technology of the present application is based.

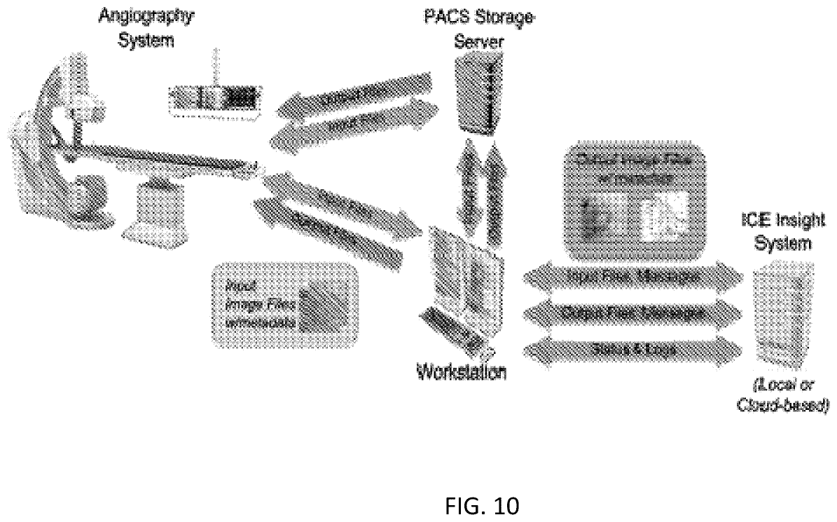

FIG. 10 shows an example of a system utilizing the technology disclosed herein for enhanced visualization of angiograms. In various implementations of the technology, any conventional angiography system can be used to obtain angiography images (or videos) of a patient. The angiography images (or videos) are then sent to a storage server, where the images (or videos) (e.g., in DICOM format) are stored for further processing. The stored images can be retrieved to a workstation where the original and/or processed images can be displayed. In some embodiments, the workstation includes a post-processor for applying the post-processing algorithms disclosed herein to the retrieved angiogram images (or, in case of videos, to still frames) and the post-processed images are displayed at the workstation. In some embodiments, the post-processing is performed on a cloud-based server. In such embodiments, the workstation may be connected to the cloud via a network.

A technician operating the workstation can perform various adjustments such as, for example, adjusting the contrast or saturation, to the post-processed images to obtain images that optimally display the various features in the angiograms as discussed herein.

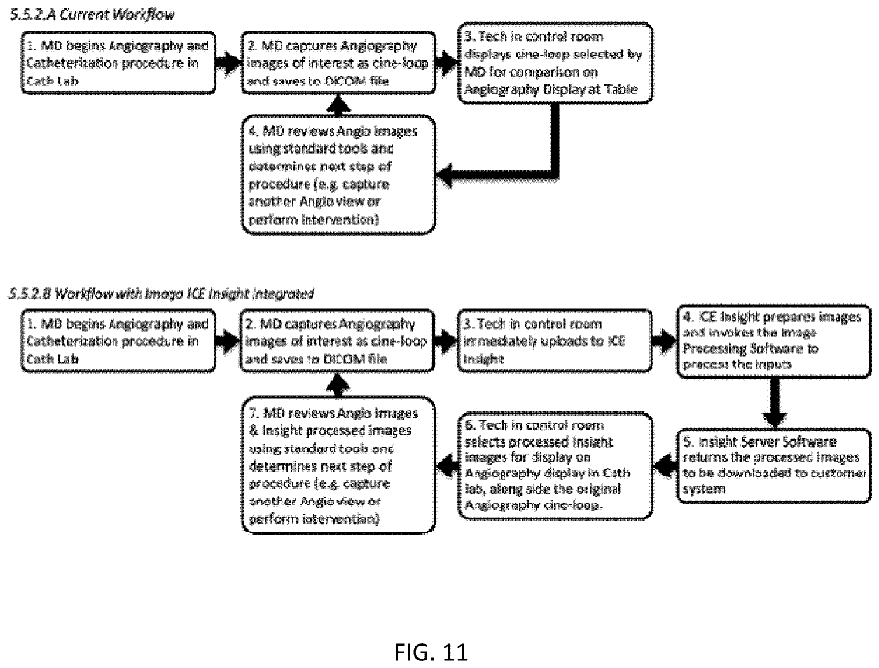

FIG. 11 shows a comparison between a conventionally used workflow of analyzing angiography images and an example workflow utilizing the technology disclosed herein for enhancing the visualization of angiography images. The top panel in FIG. 11 shows the conventional workflow used for analyzing angiography images, and the bottom panel shows an example of a modified workflow that utilizes the post-processing algorithm disclosed herein for visualizing and analyzing angiography images. The ICE Insight referred to in FIG. 11 refers to a program module that processes the angiography images using any of the algorithms disclosed herein. Thus, the modified workflow includes the additional steps of initiating, by the technician, the post-processing of obtained angiography images using, e.g., ICE Insight; performing the post-processing at an ICE Insight server; and retrieving the post-processed images from the ICE Insight server. As has been discussed herein, the ICE Insight server may be local to the workstation used for displaying the images or reside on the cloud.

Original DICOM still or video image sequences can be sent to the technology's processor through cable or from a network located in the clinical facility. It can also be uploaded to a Cloud-based server for processing and then returned to the clinic for viewing.

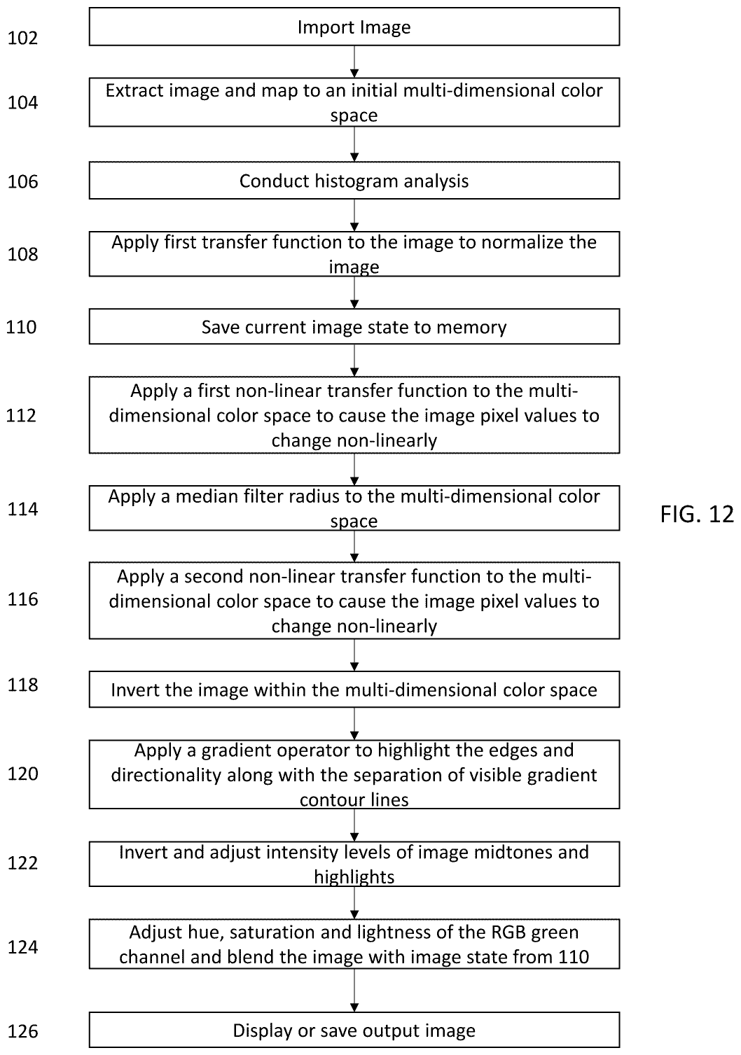

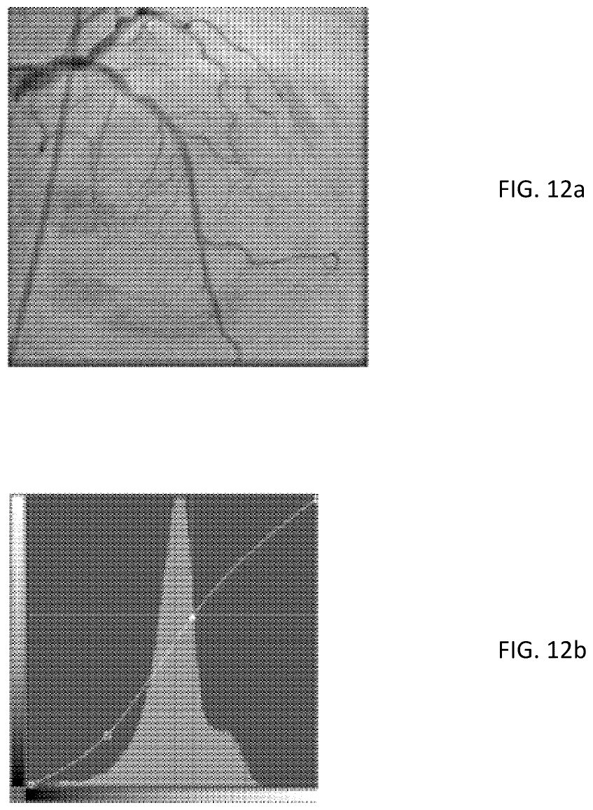

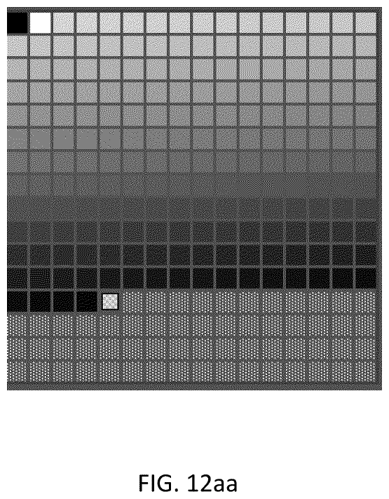

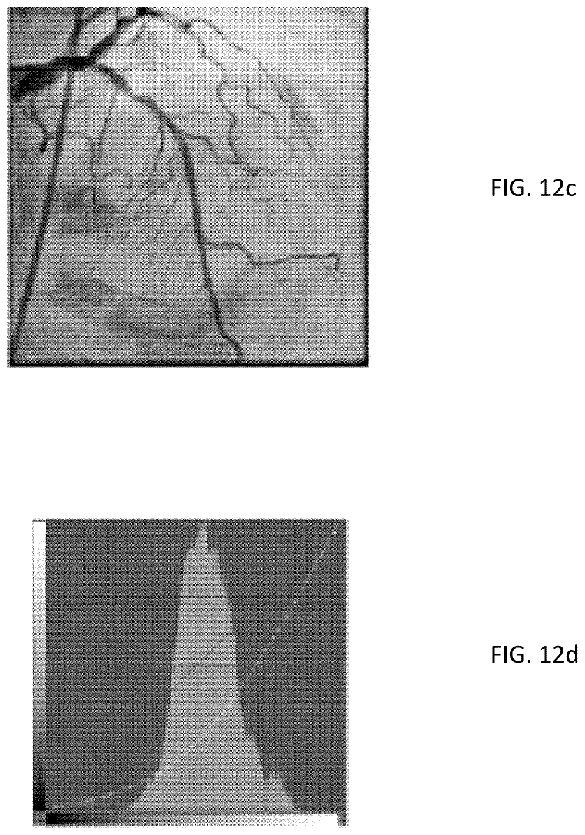

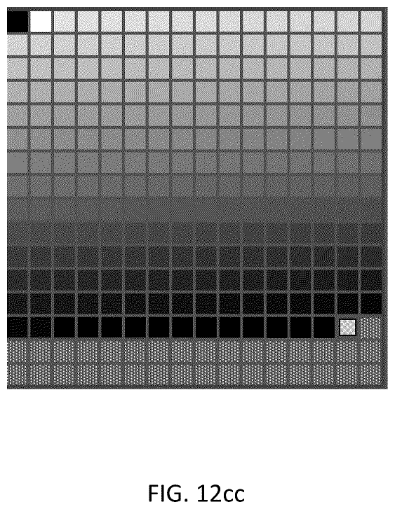

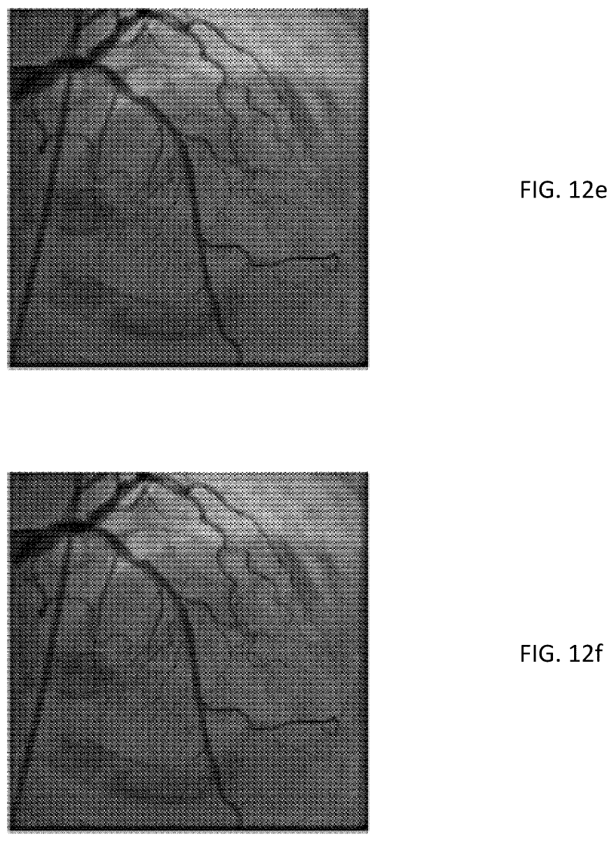

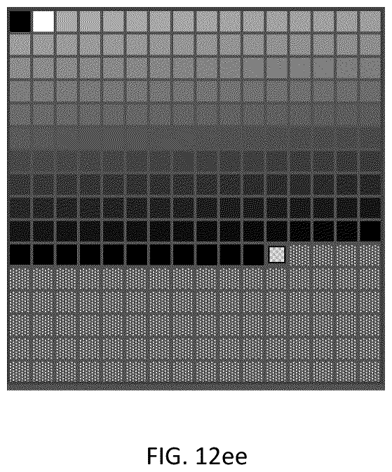

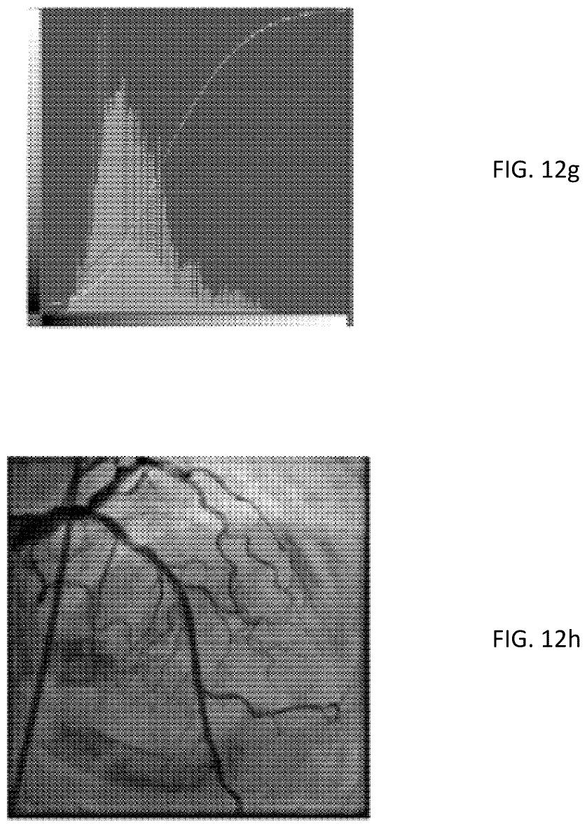

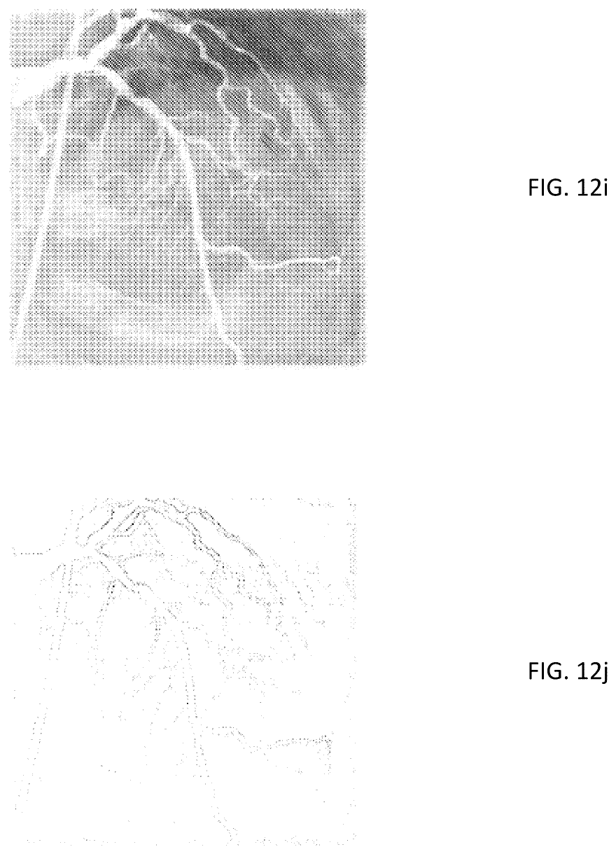

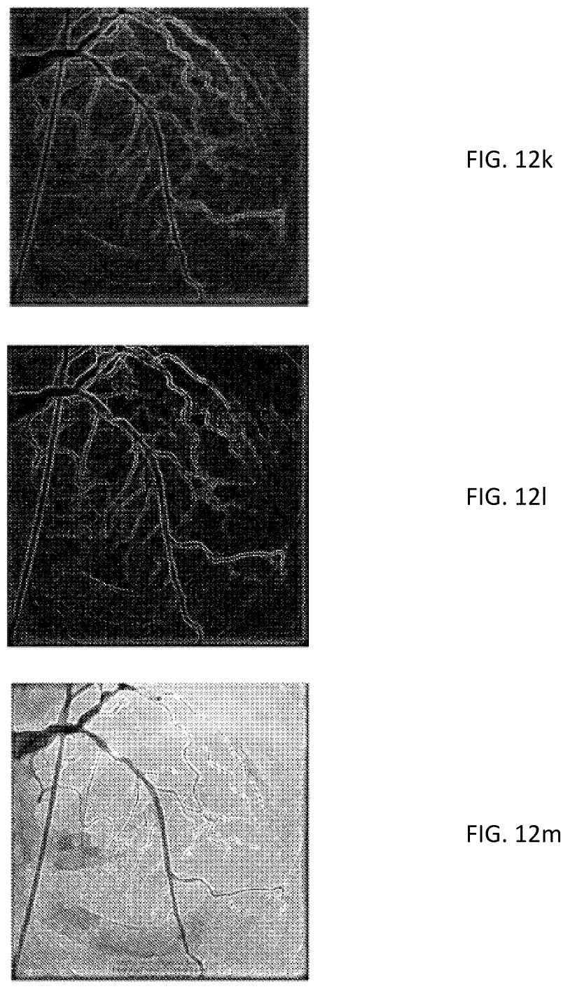

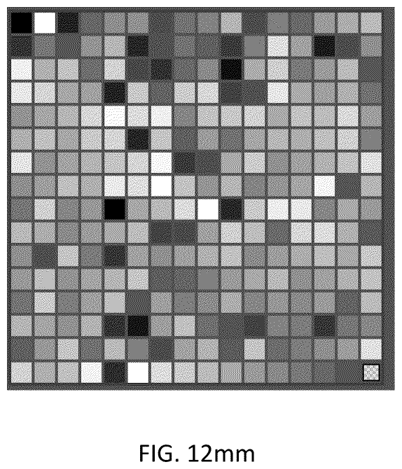

FIG. 12 shows a flow chart illustrating the method for creating a digital visualization from a grayscale or color original image in accordance with an embodiment of the present disclosure. The method includes, at 102: Importing a DICOM cardiology image or lossless image format. The DICOM container contains a lossless JPG image and the corresponding metadata related to that image. The image is extracted from the container using a known methodology. FIG. 12a shows an original angiogram frame extracted from DICOM and mapped to an initial multi-dimensional color space. FIG. 12aa shows a variety of pixel colors/grays in the original image shown in FIG. 12. It is known as “color depth” or “bit depth.” Color depth refers to the amount of information available for representing colors in each pixel of an image.

At 104, Image is extracted from DICOM and mapped to an initial multi-dimensional color space. The multi-dimensional color space, in this instance, is RGB color space.

At 106: histogram analysis is conducted on the image. A histogram is a graphical representation of a frequency distribution as illustrated in FIG. 12b. The data is divided into class intervals and denoted by rectangles. The rectangles are made on the X axis. On the Y axis, the analyst plots the frequencies of the data. Each rectangle represents the number of frequencies that lie within that particular class interval. Then the standard deviation of the normal distribution is calculated, by subtracting the average from each data value, squaring the result and taking the average of all the results.

At 108: selected transfer function, as illustrated in FIG. 12b in the form of a histogram curve, is applied to the image based upon analysis to normalize the image, as seen in FIG. 12c. A histogram curve adjusts the tonal range and color balance of an image. FIG. 12cc shows the color depth for the image of FIG. 12c.

At 110: the current image state and all other states are saved to memory.

At 112: a first non-linear transfer function is applied to the multi-dimensional color space to cause the image pixel values to change non-linearly. FIGS. 12d and 12e illustrate the application of the first non-linear transfer function, and the resultant image after applying the first non-linear transfer function respectively. The first non-linear transfer function darkens the contrast within the original image while brightening portions surrounding the object of interest for better edge differentiation within the object. The function is variable and can be adjusted based on imaging modality, object type and desired visual output. FIG. 12ee shows the color depth for FIG. 12e.

At 114: a median filter is applied to the multi-dimensional color space. FIG. 12f shows application of a median filter radius 10 to the multi-dimensional color space. One example of the selected transfer function is blurring function such as a median filter that results in smoothing the image.

At 116: a second non-linear transfer function, FIG. 12g, is applied to the multi-dimensional color space to cause the image pixel values to change non-linearly. FIGS. 12g and 12h illustrate the application of the second non-linear transfer function, and the resultant image after applying the second non-linear transfer function respectively. At 118: the image is inverted within the multi-dimensional color space. The second non-linear transfer function is configured to map a magnitude of luminance variance to a color palette (e.g., RGB)

At 120: a gradient operator 3×3 is applied to highlight the edges and directionality along with the separation of visible gradient contour lines. In one implementation, the directional derivatives and the gradient operator combine the derivative magnitudes by squaring, adding, and taking the square root. Both components: horizontal (x) and vertical (y) are used, as illustrated in FIG. 12i. The operator may be applied in both horizontal and vertical directions, thereby making the operator insensitive to or biased to orientation of edges.

At 122: intensity “levels” of image midtones (e.g., gamma 0.3) are inverted and adjusted, and highlights are provided (See FIG. 12k). At 124: optionally, the hue, saturation, and lightness of the RGB green channel are adjusted. FIG. 12l shows the result of hue (0), saturation (0.2) and lightness (0).

At 124: The image state from step 11 is blended with the image state from step 4.5 using “lighten” blend function as seen in FIG. 12m. At 126: the image from 124 is displayed or saved. FIG. 12mm shows the color depth of FIG. 12m.

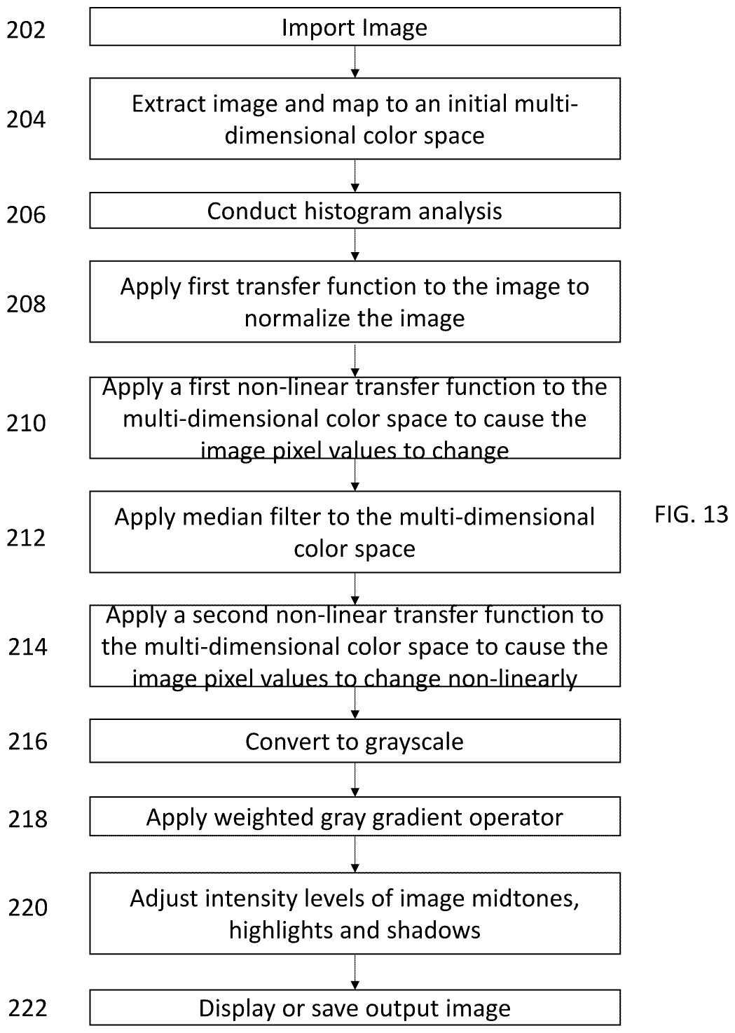

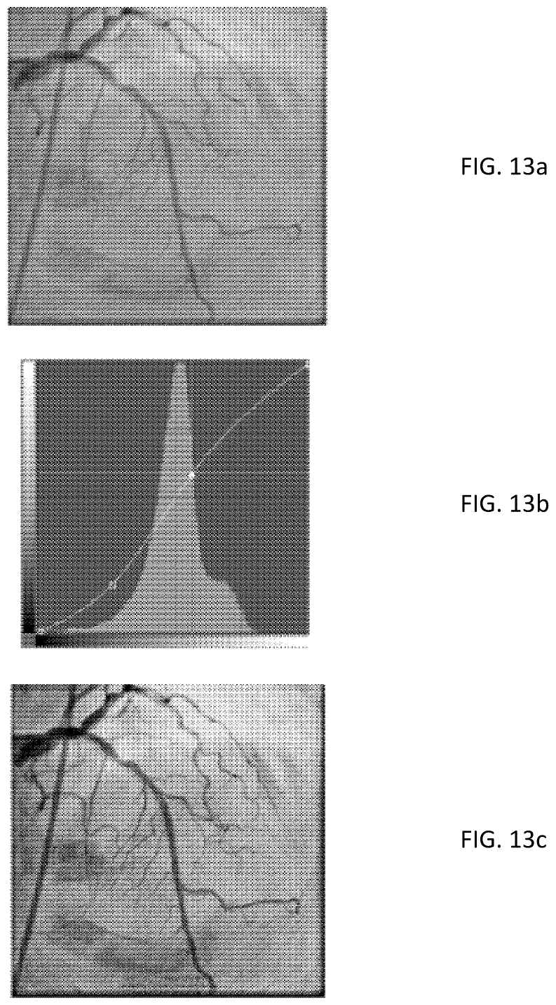

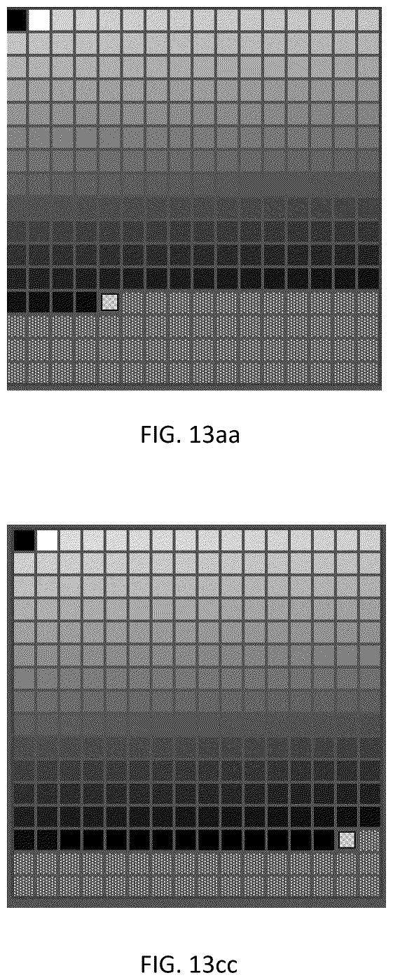

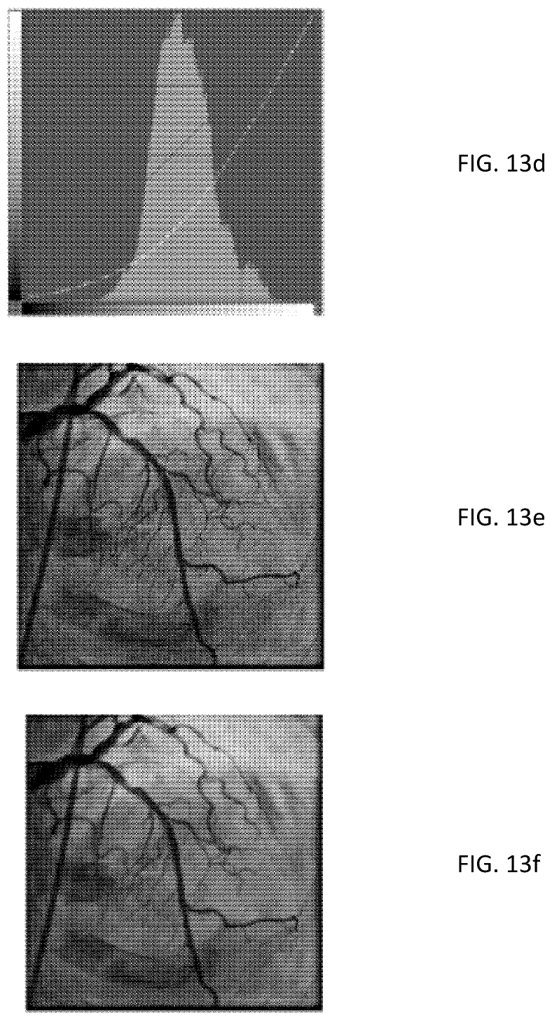

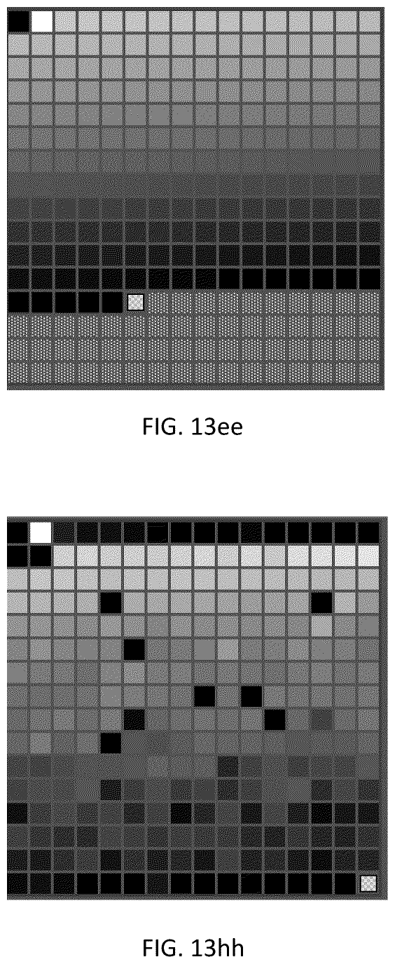

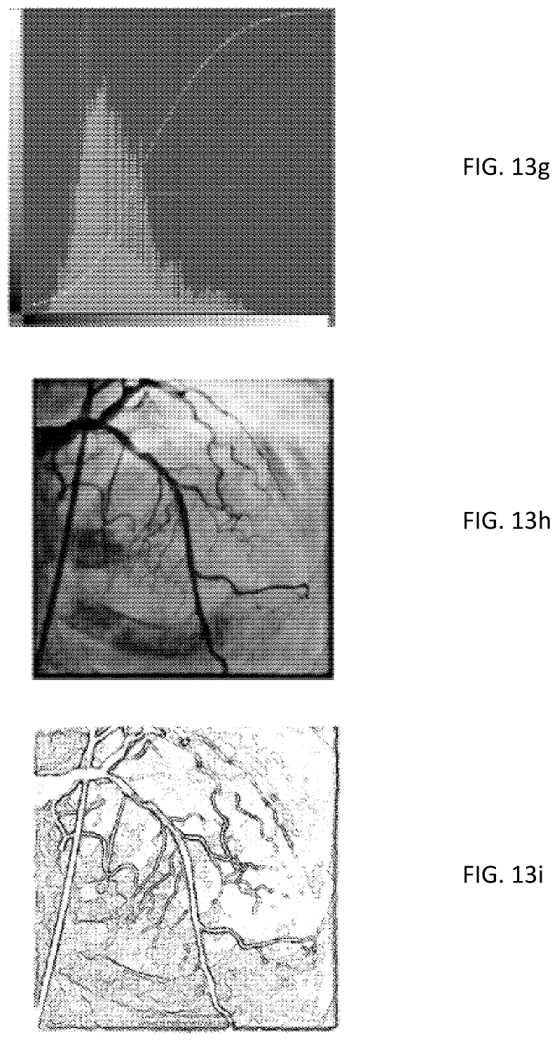

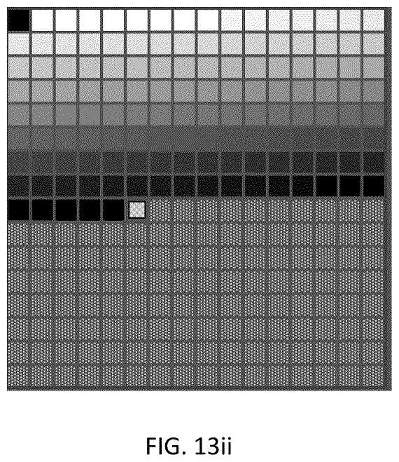

FIG. 13 shows a flow chart illustrating another method for creating a digital visualization from a grayscale or color original image. The method involves, at 202: importing a DICOM cardiology image or lossless image format, e.g., one shown in FIG. 13a. The DICOM container contains a lossless JPG image and the corresponding metadata related to that image. The image may be extracted from the container using any known methodology.

At 204: Image is extracted from DICOM and mapped to an initial multi-dimensional color space. See, e.g., FIG. 13a. The multi-dimensional color space is RGB color space. FIG. 13aa shows the variety of pixel colors/grays in the image of FIG. 13a. At 206: histogram analysis is conducted on the image. A histogram is a graphical representation of a frequency distribution as can be seen in FIG. 13b. The data is divided into class intervals and denoted by rectangles. The rectangles are made on the X axis. On the Y axis, the histogram plots the frequencies of the data. Each rectangle represents the number of frequencies that lie within that particular class interval. Then the standard deviation of the normal distribution is calculated, by subtracting the average from each data value, squaring the result and taking the average of all the results.

At 208: the selected transfer function, as illustrated in FIG. 13b (in the form of a histogram curve), is applied to image based upon analysis to normalize the image. The resultant image is shown in FIG. 13c. The histogram curve adjusts the tonal range and color balance of the image. FIG. 13cc shows the color depth for FIG. 13c.

At 210: a first non-linear transfer function is applied to the multi-dimensional color space to cause the image pixel values to change non-linearly. FIGS. 13d and 13e illustrate the application of the first non-linear transfer function, and the resultant image after applying the first non-linear transfer function respectively. The first non-linear transfer function darkens the contrast within the original image while brightening portions surrounding the object of interest for better edge differentiation within the object. The function is variable and can be adjusted based on imaging modality, object type and desired visual output. FIG. 13ee shows the color depth for FIG. 13e.

At 212: a median filter is applied to the multi-dimensional color space. FIG. 13f shows the resultant image using median filter radius 12. One example of the selected transfer function is blurring function such as a median filter that results in smoothing the image.

At 214: a second non-linear transfer function, illustrated in FIG. 13g, is applied to the multi-dimensional color space to cause the image pixel values to change non-linearly. FIGS. 13g and 13h illustrate the application of the second non-linear transfer function, and the resultant image after applying the second non-linear transfer function respectively. The second non-linear transfer function is configured to map a magnitude of luminance variance to the image. FIG. 13hh shows the color depth for FIG. 13h.

At 216: the image is converted to grayscale. As an example, the resultant image of adjusting Reds to 2, Yellows to 25, Greens to 40, Cyans to 120, Blues to 118, and Magentas to 40 is shown in FIG. 13i. At 218: a Weighted Gray 3×3 gradient operator is applied to highlight the edges and directionality along with the separation of visible gradient contour lines. Directional derivatives and the gradient operator combining the derivative magnitudes by squaring, adding, and taking the square root. Both components: horizontal (x) and vertical (y) are used. See FIG. 13i.

At Step 220: the intensity “levels” of the image are adjusted. FIG. 13i shows the resultant image when the parameters are midtones (2.0), highlights (255) and shadows (120).

At 222: Display or save output the image from 220.

Thus, in the field of medicine, and more specifically, cardiovascular medicine, the technology disclosed herein can post-process images generated from X-ray/fluoroscopy, ultrasound, Computerized Tomography (CT), magnetic resonance imaging (MRI), Positron Emission Tomography (PET), hyperspectral images, mm-wave images, Infrared (IR) images, etc. The result are two or more new images generated from the original images. As a result, the technology disclosed herein supports procedures in X-ray angiography, CT angiography (CTA), heart ultrasound, and peripheral vascular clinical applications such as those in the brain, lung, kidney, carotid arteries, and extremities. This is possible because the sequence of processing is insensitive in function to the orientation of edges of vessels and so is extensible for imaging structures throughout the body.

The transforms disclosed herein can reveal many of the following properties in one image: Vessel wall structures including blocked vessels, plaque, aneurisms, and ruptures; Hemodynamic flow—flow direction, oscillations (diastole vs. systole), velocity; Strain and stresses in wall shear stress; Degree of anisotropy (different directions); Changes from laminar flow to turbulent flow; Vascular geometry—diameter, length of stenosis, curvature, stiffness.

The technology can be deployed globally without the need for capital equipment purchases by hospitals or clinics, so there is no disruption to cath labs or the clinical team. There is no delay in viewing the images and doesn't require invasive devices to be put in patients, or for chemicals to be injected into the patients as is the case in many currently used procedures.

### EXAMPLES

### Example 1: Vessel Centerline Detection and Cross-section Measurements

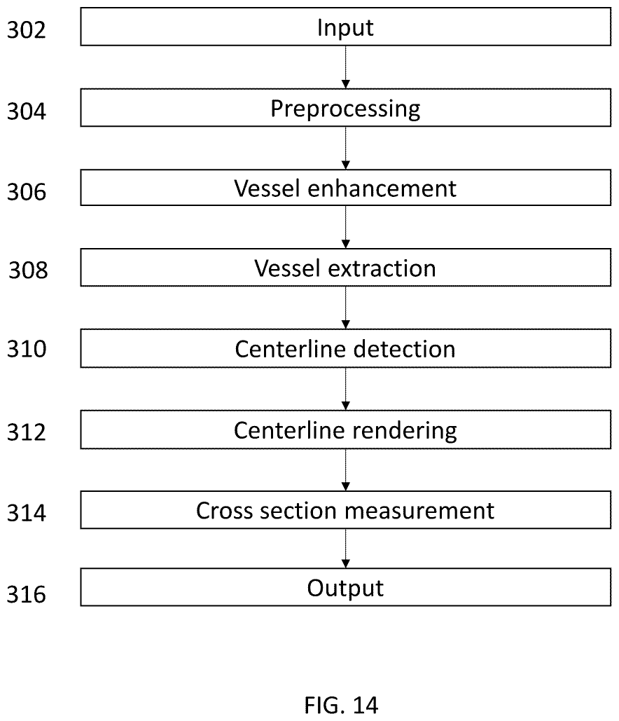

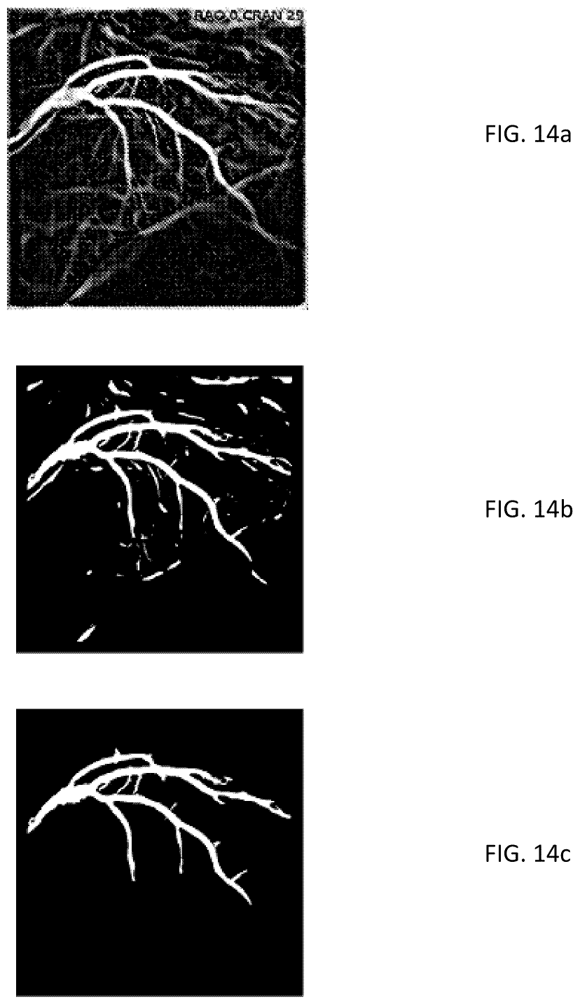

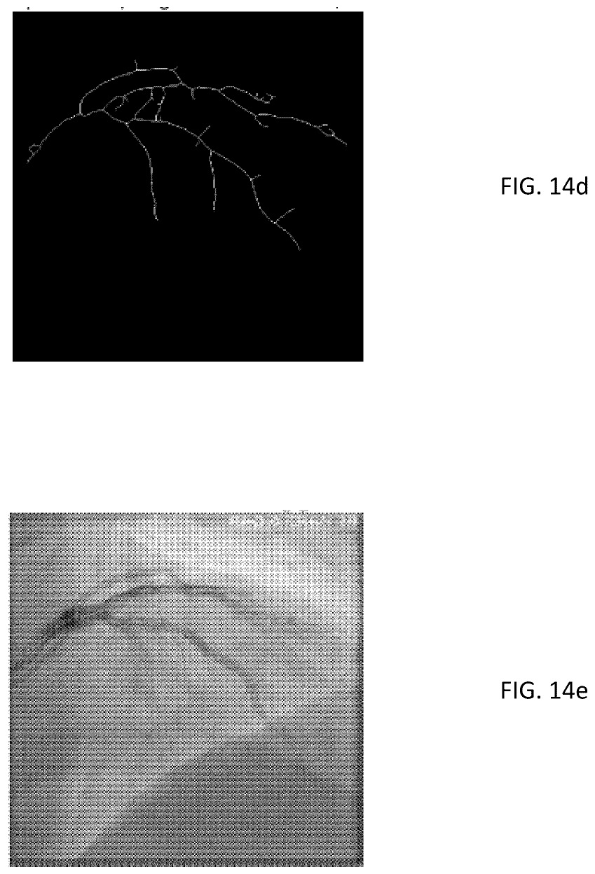

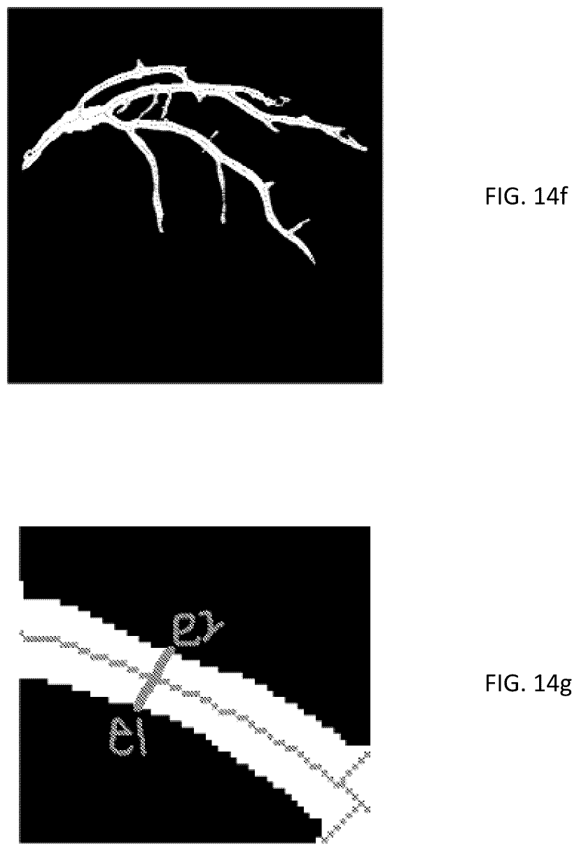

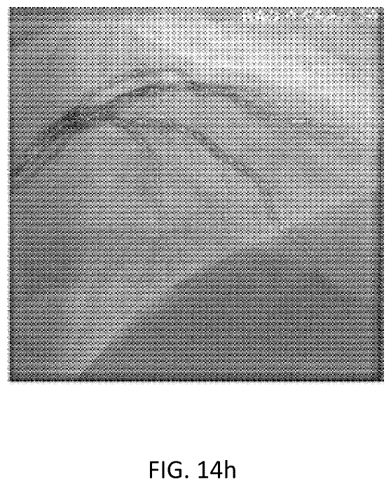

One of the applications of the present technology is detection of the vessel centerline and measurement of vessel cross-section using enhanced angiogram images. FIG. 14 shows a high-level workflow for performing vessel centerline detection.

At 302, an image enhanced using an algorithm disclosed herein is input to a vessel detection algorithm. At 304, during preprocessing, noise reduction is performed using a Gaussian filter and the RGB image is converted to grayscale image. This serves to reduce the random noise in the image.

At 306, a Hessian filter is used to enhance the vessel area while the non-vessel area is suppressed. The resultant is shown in FIG. 14a.

At 308, during vessel extraction, the pixels that belong to the vessel area and pixels belong to the background (i.e., non-vessel area) are identified by sequentially applying thresholding on the image shown in FIG. 14a to get a binary image, as shown in FIG. 14b, followed by finding the largest connected component in the binary image. The resultant is shown in FIG. 14c.

At 310, during centerline detection, a thinning algorithm is performed to obtain the centerline as shown in FIG. 14d. At 312, the centerline obtained in FIG. 14d is superimposed on the input image (i.e., FIG. 14a) using a preferred color, as shown in FIG. 14e, to render the centerline on the input image.

In order to measure the vessel cross-section, at 314, the centerline obtained in FIG. 14d is combined with the binary image obtained in FIG. 14c. The combined image is shown in FIG. 14f, where the centerline is displayed on the binary image. For a given point on the centerline, a line perpendicular to the direction of the centerline is drawn as illustrated in FIG. 14g. Two edge points, e1 and e2, are then determined, as shown in FIG. 14g. The distance between e1 and e2 can be considered as the measurement of the cross-section of the image.

At 316, the detected centerlines and measured cross-sections are displayed on the vessel area as the output, as shown in FIG. 14h.

The output can be a full size image without red line marks, and vessel segment marked by red lines, in some embodiments.

In some embodiments, the implementation of the vessel enhancement can be performed using a multiscale Hessian filter from the ITK library. One reason the Hessian filter was selected because it is good at detecting the tube-like shapes which fit into the use case of detecting vessel centerlines.

### Example 2: Performance Testing the Visualization Algorithm

Performance testing is standardized by having a range of “targets” of varying size, shape, and contrast embedded in a range of “tissue” backgrounds. In X-ray Angiography, the relative contrast between the vessel and surrounding tissue is dependent on a number of factors, including the amount of dye in the vessel, the shape of the vessel, the angle of the X-ray plane, the presence of other overlying structures, etc. These clinical factors impact the image content and, thus, the resulting performance of the disclosed algorithms. The testing method is derived directly using data contained in clinically obtained images with a goal of including a variety of image content. It is designed to represent a wide range of imaging conditions encountered clinically in a small number of images with known conditions. Testing with the digital phantom is just one portion of verification testing and is used to supplement the use of clinically obtained images in verification testing.

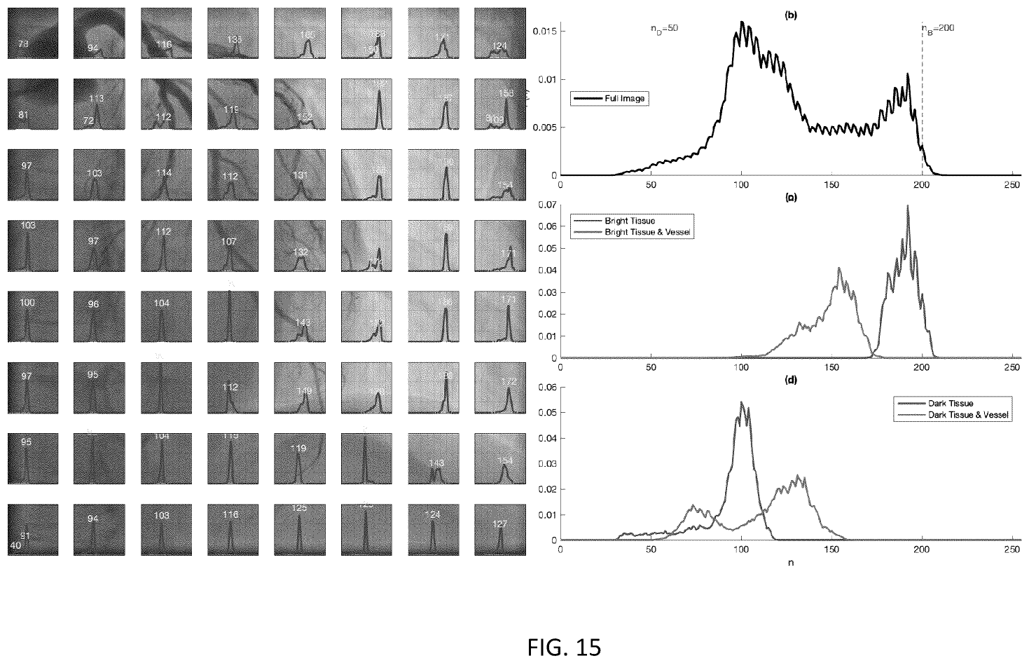

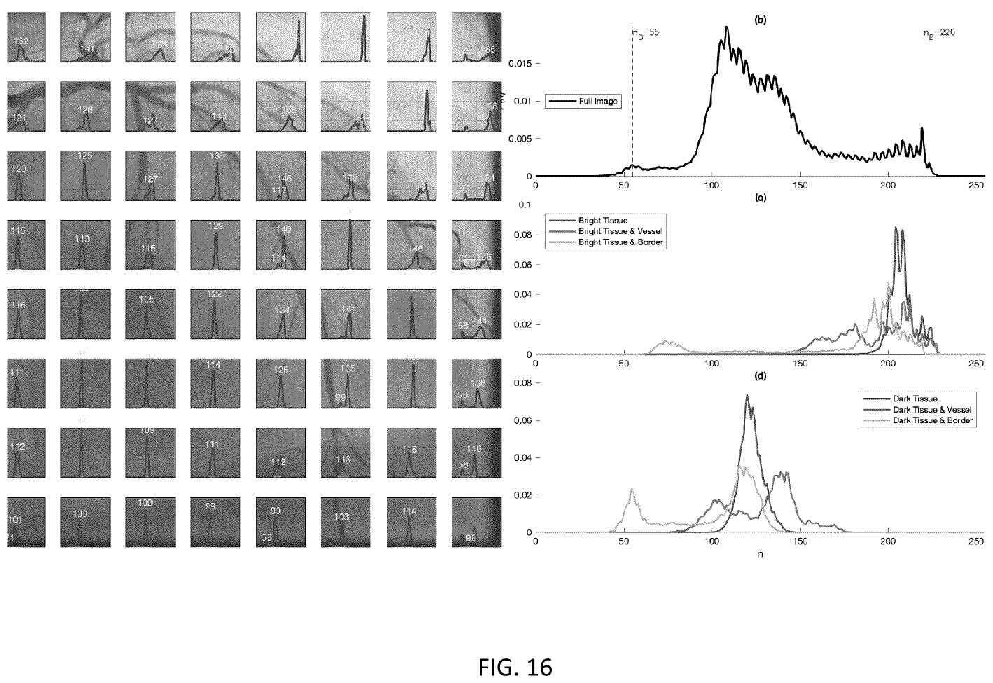

FIGS. 15 and 16 show two examples of clinically obtained X-ray Angiography images and a sample analysis of the range of pixel values contained in them. Differences in the brightness of the non-vessel regions of the images can be due to a number of factors, including the positioning of the patient within the angiography system, the angle of the C-arm detector affecting which anatomy is overlying or underlying the area of imaging, as well as other imaging acquisition settings of the system. The goal of the use of a digital phantom in Imago's testing is to simulate a complete range of background (non-vessel) areas that may be encountered but in a more standardized environment. Therefore, the “tissue,” or the non-target background values in the digital phantom, takes into account the distribution of background tissue values present in clinically obtained X-ray angiography images such as those shown below.

FIG. 15 demonstrates a sample analysis of a clinical image. The full image is shown on the left in FIG. 15, Panel (a) divided into 64 sub-images (256×256). The histogram of each sub-image is overlaid on top of the sub-image itself for demonstration purposes. On the right, the top graph in FIG. 15, Panel (b) shows the histogram of the full image. Below that in FIG. 15, Panel (c) two histograms are shown from two regions in the image which contain brighter tissue. A sub-image region which appears to contain just tissue is shown in blue and a sub-image area for a region which contains a vessel segment and tissue is shown in red. The presence of the vessel shifts the distribution of pixel values lower. Similarly in FIG. 15, Panel (d) two histograms are shown in a darker area of the image. Again, the just tissue sub-image histogram is shown in blue and the sub-image region with tissue and vessels is shown in red.

FIG. 16 demonstrates another sample analysis of a different clinical image. The full image is shown on the left in FIG. 16, Panel (a) divided into 64 sub-images (256×256) with the histogram of each sub-image overlaid on top of the sub-image. On the right, the top graph in FIG. 16, Panel (b) shows the histogram of the full image. Note this image contains a dark area on the right and bottom image border due to alignment of the fluoroscopy equipment, which is reflected in a small peak in the histogram near the pixel value 55. In FIG. 16, Panel (c), the middle subplot, three histograms are shown from two regions in the image that contain brighter tissue. A sub-image region that appears to contain just tissue is shown in blue and a sub-image area for a region that contains a vessel segment and tissue is shown in red. The gold line shows the histogram of a sub-image that contains a dark border area due to the alignment of the fluoroscopy equipment. This shows a similar central group of dark tissue pixel values and an additional peak at much lower pixel values due to the dark border. Similarly, in FIG. 16, Panel (d) three histograms are shown in a darker area of the image. Again, the tissue-only sub-image histogram is shown in blue, the sub-image region with tissue and vessels is shown in red and the sub-image histogram with tissue and border is shown in gold.

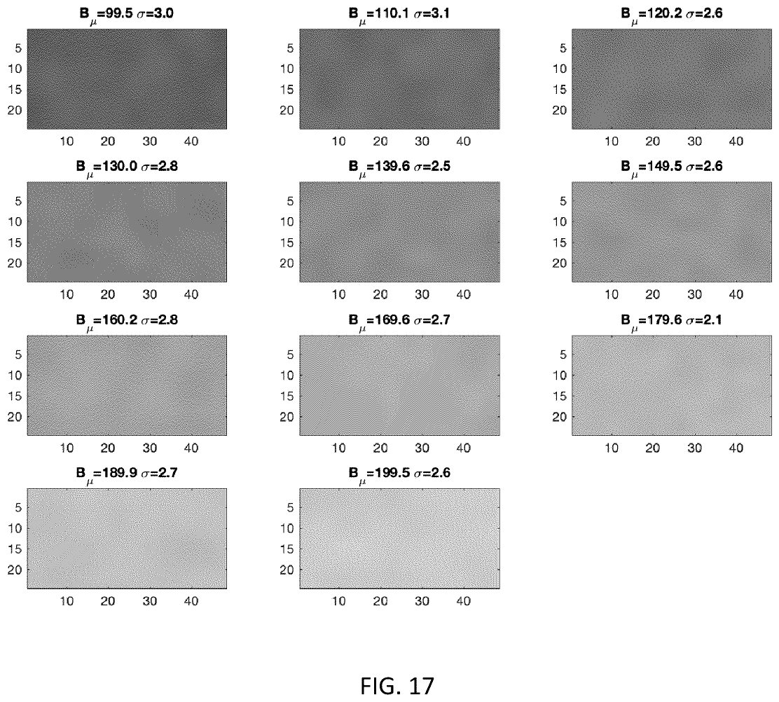

The type of analysis above was performed on even smaller sub-images (24×24). Each sub-image was then categorized as a vessel or tissue background or a combination of both. Any given image frame contains over seven thousand of these sub-images, and those that were determined to be primarily background were collected from 25 different clinical cases acquired through a retrospective clinical data acquisition protocol for use in the phantom. These sub-images were then sorted by mean value and standard deviation. Examples of the sub-images are shown in FIG. 17.

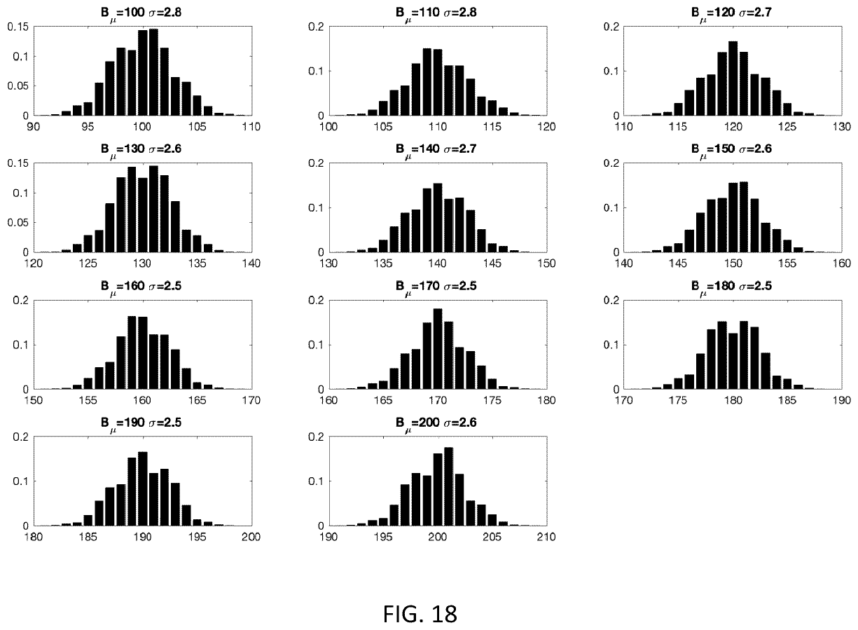

To create a single area of tissue background comprised of clinical sub-images, a group of approximately 1800 sub-images with a common mean was selected amongst all the sub-images and randomly arranged as a 125×15 matrix for a new sub-image size of 3000×360. Each tissue area thus represents a common mean and representative standard deviation of the tissue background found in the clinical images. In total, eleven such “tissue” region groups with mean values ranging from 100 to 200, in steps of 10, were created and used in the digital phantom. With this design, the phantom has a standardized range of background values and includes representative noise commonly encountered in the angiograms. FIG. 18 shows the distribution of each of these 11 full tissue groups contained in the digital phantom images.

The “targets” embedded in the digital phantom are meant to represent a range of vessels encountered in the clinical image. For this clinical application, the targets simulate dark vessels surrounded by lighter tissue, as opposed to other applications and modalities, which often have test targets with both lighter and darker contrast. These simulated targets have three parameters that are varied: diameter, shape, and contrast, and a representative range of these parameters were included in the digital phantom after analyzing hundreds of clinical sub-images. To represent a range of target vessel shapes encountered in the clinical vessel segments, the simulated target shapes were defined by

$$T ( x , y ) = \{ \begin{matrix}B ( x , y ) - {C}_{o} {\vert r ( x , y ) - {c}_{o} \vert}^{pow} & r ( x , y ) \leq {r}_{o} \\ B ( x , y ) & r ( x , y ) > {r}_{o}\end{matrix}$$

where B (x, y) is the background tissue value, Cₒ is the nominal contrast between the Target and the background, rₒ is the radius of the target centered at cₒ, and pow is the power of the polynomial function. As discussed above, the background tissue function B(x,y) is taken directly from clinical images and varies in the x,y coordinates but has a common mean and standard deviation for each target group. The polynomial functions such as |r(x, y)−cₒ|^{pow} are familiar; when pow=1, it is a linear ramp centered at cₒ, when pow=2 it is a parabolic function, etc. For the development of the phantom, over 100 vessel cross-sections were analyzed, and a least square regression analysis was used to estimate the values of the nominal contrast (Cₒ), radius (rₒ), and the shape (pow) using an estimated mean background value Bμ.

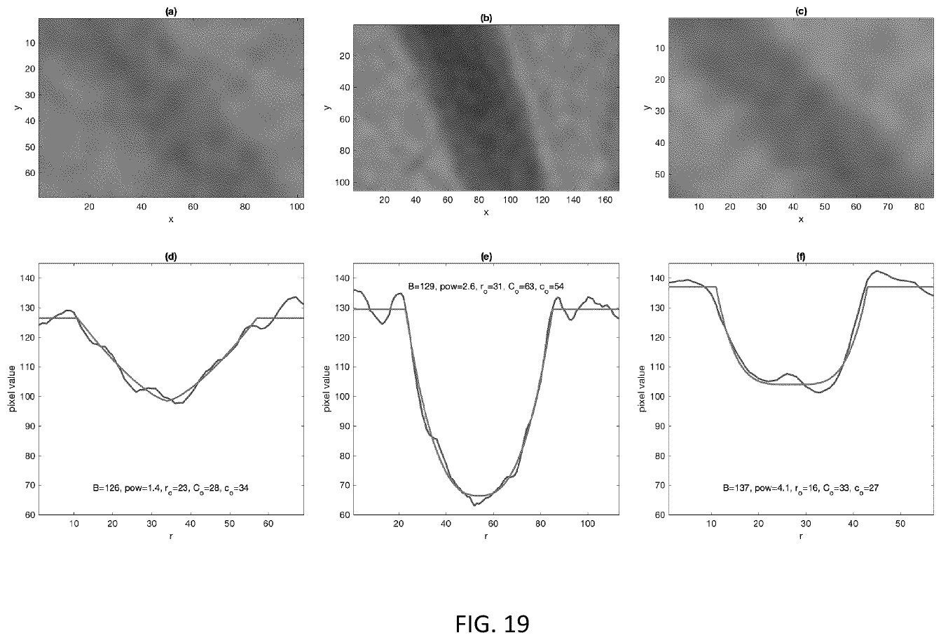

FIG. 19 shows just three examples of the vessel sub-images and cross-sections used to develop the digital phantom. The first row, FIG. 19, panels (a)-(c), shows three different vessel segments. The plot below each sub-image, FIG. 19, panels (d)-(f), shows the corresponding cross-sections extracted from the sub-image in blue and the fit polynomial from the equation above in red. For the first sub-image in FIG. 19, panel (a), the fit red line in FIG. 19, panel (d) has a mean tissue value of 126, a polynomial power of 1.4, a radius of rₒ=23, and a nominal contrast of Cₒ=28. For the second sub-image shown in FIG. 19, panel (b), the fit red line in FIG. 19, panel (e) has a mean tissue value of 129, a polynomial power of 2.6, a radius of rₒ=31, and a nominal contrast of Cₒ=63. For the third sub-image shown in FIG. 19, panel (c), the fit red line in FIG. 19, panel (f) has a mean tissue value of 137, a polynomial power of 4.1, a radius of rₒ=16, and a nominal contrast of Cₒ=33. Note in the above examples, the fit line is shown with a simple offset B_{μ} so these lines do not include any noise. In the digital phantom, however, there is noise with a distribution similar to that found throughout the original angiograms (σ≅2.5), added to the targets using the B(x, y) background, which is of an overall mean B_{μ} but varies in the x and y dimension due to noise inherent in the Angiogram image.

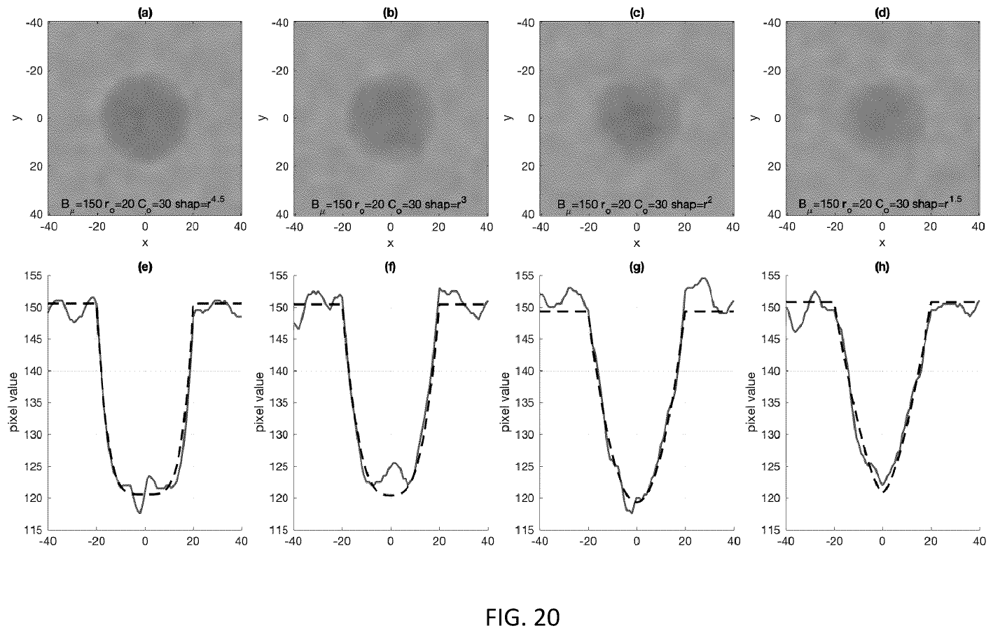

Based on the analysis discussed above, the digital phantom was developed to include a range of targets representing a range of shapes, sizes, and contrasts. The diameters included in the phantom range from 20 pixels to 80 pixels. Note that in the 2048×2048 full-size angiograms, the pixel spacing is 0.064 mm so this range of pixels is equivalent to 1.3-5 mm. The nominal contrast in the clinical image vessels was estimated by measuring the difference between the surrounding tissue and the darkest part of the vessel, which was then matched in the simulated targets. Note that this nominal contrast value is the maximum difference between the background tissue and the vessel; however, depending on the shape of the vessel or target (discussed next), the perceived contrast is different. The last parameter is the vessel shape which is best visualized by looking at the cross-section of a vessel or target with the x or y pixel dimension on the x-axis and the pixel value on the y-axis, as shown in FIG. 19. In this case, the analysis of the clinically obtained images found vessel cross-sections ranging from gradual lower-order functions, such as that shown in FIG. 19, panel (d), all the way to much steeper, nearly inverted rectangular functions, such as that shown in FIG. 19, panel (f). For ease of computation and to reduce digital phantom image sizes, the modeled targets have been simplified to be circular targets. FIG. 20, panels (a)-(h) show four example sub-images, including these test targets from the digital phantom.

Based on this modeling, a set of 42 targets similar to those shown above was developed. For this set of targets, the nominal contrast varied from 20 to 70 (for 8-bit images 0-255 possible values), and the power of the polynomial function modeling the vessel target ranged from 1.5 to 4.5. These 42 targets were repeated in 11 groups of similar background tissue values ranging from 100 to 200 for each of the four radii varying from 10 to 40 pixels. The groups of similar background tissue and Target combinations were then repeated with a maximum of five consecutive tissue background value combinations in a single test image, for a total of 12 Phantom images and 2520 individual targets.

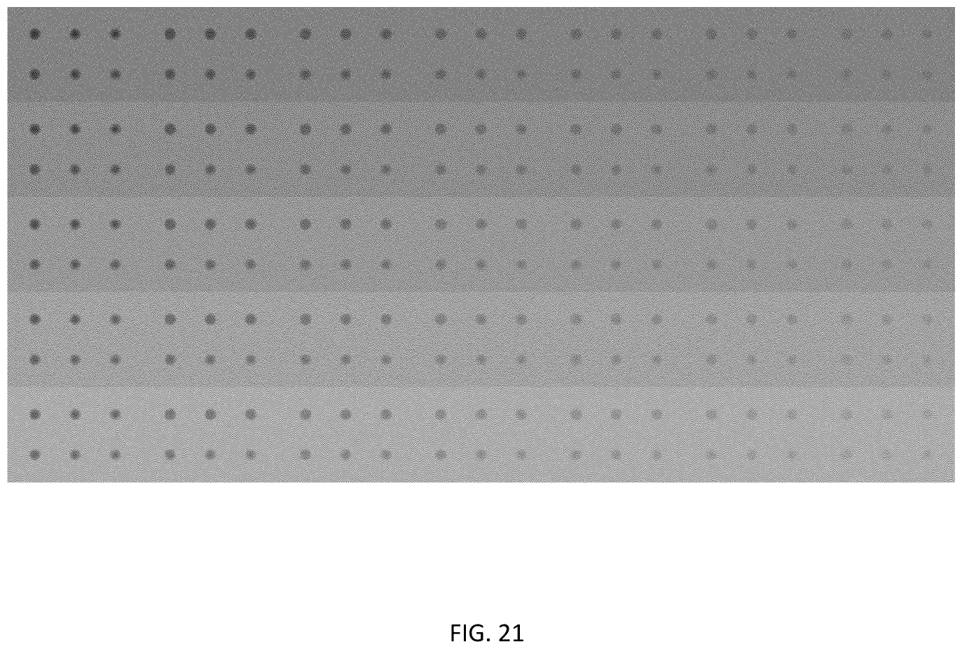

An example of just one of these phantom test images is shown in FIG. 21. This image represents one target size (radius of 20 pixels) and grouping of five tissue brightness, and the full range of target shapes and contrasts. Note that the range of targets encompassed in the set of digital phantom test images represents an equal number of commonly encountered and less frequently encountered target conditions (i.e., there is no weighting in the phantom of the more commonly encountered conditions). The tissue background groups were chosen such that the entire range of pixel values contained in a given test image was representative of pixel values contained in a typical clinically obtained image. Specifically, if we were to include the full range of tissue values and target contrasts in a single image, the full range of grayscale values in the test image (Image Contrast) would be much higher than that of the clinically obtained images.

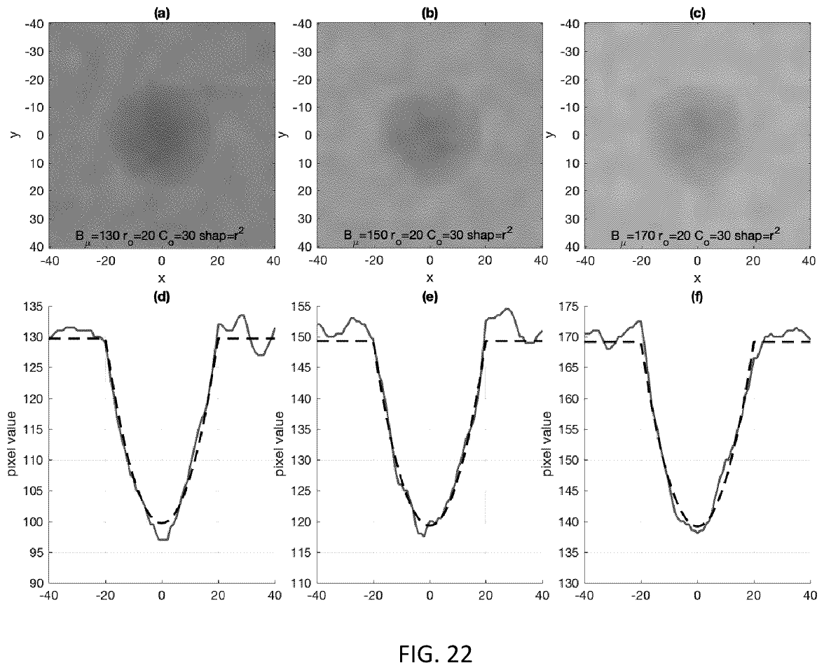

Note that each set of 42 targets, which are repeated in each major region containing similar background tissue, are identical prior to incorporating the background tissue. However, once the background tissue is added in, the natural variation (noise), which is inherent to Angiogram images, results in variation among the targets which is visible in the cross-sections. This is evident in three such targets with the same shape and contrast shown in FIG. 22, panels (a)-(f).

The final digital phantom images to be used as a part of verification testing is considered a verification tool.

### Example 4: Image Performance Metrics and Testing

The enhanced output image performance is characterized by comparing standard image quality measurements between the original input angiogram and the enhanced output images using both an Imago-developed digital phantom and clinical images. These tests measure the imaging performance improvements as defined by the requirements by utilizing regions of interest within each test image (e.g., targets in the phantom or vessel segments in the clinical images) as well as over the entire image using accepted Image Performance Metrics.

One goal of the Color Algorithm is to increase contrast and sharpness without reducing the information in the image. One goal of the Grayscale Algorithm is to also increase contrast and sharpness while simplifying the information in the image. In the following sections, we define the metrics used to quantify the enhancement of contrast, sharpness, and entropy. In medical imaging literature, image performance metrics can be defined in many different ways. Selection of specific metrics in the context of the Insight image enhancements is required due to the differences between input and output images. In general, for this application, in the original image, the target is darker (lower pixel value), and the tissue is brighter (higher pixel value). In the Imago enhanced output images, this is not true. In the Color output, the pixel values of the color Connected Pixel Value (CPV) lines in the target will generally be higher than the background tissue pixel values. For the grayscale output, the pixel values of the CPV lines in the target will generally be lower than the background tissue pixel values. The metrics described in the following sections were carefully chosen to best represent the visual enhancements offered by the algorithms disclosed herein. Additionally, it is important to note that while the individual image performance metrics quantify the changes in contrast, sharpness and entropy, the overall enhancement produced by the use of algorithms disclosed herein are a direct result of a combination of image transformations which result in the presence of CPV lines in the two enhanced outputs.

Image Contrast

An additional goal of the Algorithms described herein is to enhance the overall contrast of the image to maximize the usage of the available 8-bit pixel values. To quantify this enhancement in both outputs, the Image Contrast is measured as defined by the difference between the darkest part of the image and the brightest part of the image. To exclude outlying values, the darkest pixel value will be calculated at 1% of the cumulative distribution, and the brightest pixel value will be calculated at 99% of the cumulative distribution. The Image Contrast is the difference between these two values. Mathematically the Image Contrast is defined by the following equations for n=0 to 255.

Given the histogram distribution of pixel values h(n) for an image I(x, y) of dimensions X and Y

$$h ( n ) = \frac{1}{XY} {\sum }_{x = 1}^{X} {\sum }_{y = 1}^{Y} m ( x , y ) \{ \begin{matrix}m ( x , y ) = 1 & if I ( x , y ) = n \\ m ( x , y ) = 0 & if I ( x , y ) \neq n\end{matrix}$$

The Cumulative distribution of the pixel values P(n) is defined by

$$P ( n ) = {\sum }_{{n}_{k} = 1}^{n} h ( {n}_{k} )$$

Then the Image Contrast IC is defined as

IC=n_{B}−n_{D}

Where n_{D} and n_{B} are respectively the darkest and brightest (±1%) pixel values which are found from the cumulative distribution such that P(n_{D})=0.1 and P(n_{B})=0.99.

FIG. 23 shows an example of a histogram h(n) and cumulative distribution P(n) used in the Image Contrast calculation described above. The blue bars represent the normalized histogram, and the red line represents the cumulative distribution. The calculated points n_{D} and n_{B} are shown on the cumulative distribution by an asterisk and a vertical dashed line for emphasis. For this image data, the Image Contrast would be IC=n_{B}−n_{D}=200−77=123.

Entropy

Entropy is a statistical measure of randomness that can be used to characterize the texture of the image. A larger entropy is indicative of more information in the image, and a smaller entropy is indicative of less information in the image. We calculate the Entropy on the entire image for the input and two outputs and compare them. While this metric is commonly used to describe the information in the image, the interpretation of an increase or decrease in entropy is dependent on the goal of the image enhancement. In our device, the goals of each algorithm are different. Therefor an enhancement in the grayscale output image is measured by measuring a decrease in the entropy in the output image as compared to the input image, because the goal is to simplify the image information content overall, in order to focus the visualization on the margins of the vessel. On the other hand, in the color output image, the entropy is expected to increase or not decrease significantly because the goal of this algorithm is to maintain or increase the information content in the image overall and in particular the darker parts of the image typically representing the vasculature.

Entropy is calculated as follows using the image histogram:

$$ENT = - {\sum }_{n = 0}^{255} h ( n ) {log}_{2} ( h ( n ) )$$

where h(n) contains the normalized histogram counts returned from a standard histogram function at all pixel values n from 0 to 255.

For the original image, the target is darker (lower pixel value), and the tissue is brighter (higher pixel value). In the output images, this is not true. In the color output, the pixel values of the color CPV lines in the target will generally be higher than the background tissue pixel values. For the grayscale output, the pixel values of the CPV lines in the target will generally be lower than the background tissue pixel values. We calculate the entropy on the entire image because the choice of cropping affects the distribution of pixel values (histogram) contained in the image.

Sharpness is a metric that is calculated on each of the sub-images. In our output images, we expect the sharpness to increase as compared to the input images due to the edge enhancement. A larger sharpness is indicative of a less smooth or blurry image; therefore, an increase in Sharpness from input to output is a good measure of an enhancement of the edges. The sharpness metric is defined as

Sharp=1−Blur

Where 1 is the maximum possible sharpness and 0 is no sharpness. In the above equation, Blur is calculated using the standard perceptual blur metric as described by Crete, et al and available in standard image processing libraries (such as skimage.measure.blur_effect.) A kernel size of 3 is used to calculate the Blur over the smallest features in the image. As defined, the Blur metric ranges from 0 (no blur) to 1 (maximal blur). The detailed mathematical calculations for the Blur function used in our Sharpness metric are described in Crete, Frederique, et al. “The Blur Effect: Perception and Estimation with a New No-Reference Perceptual Blur Metric.” SPIE Proceedings, 2007, https://doi.org/10.1117/12.702790, which is incorporated herein by reference in its entirety. As implemented in the library, this metric already accounts for color channels in the calculation.

The image metrics described above are formulated to be calculated with a single channel or a grayscale image. Since one of our two outputs is Color and therefore contains three channels of information, we need to combine each channel calculation into a single metric. For our purposes, we calculate the combined effect of the three channels by calculating the RMS of the three different metrics calculated independently on each channel.

So, for any metric M, we first calculate the metric on each channel Mᵣ, M_{g}, M_{b} and combine them as follows.

$${M}_{color} = \sqrt{\frac{{( {M}_{r} )}^{2} + {( {M}_{ℊ} )}^{2} + {( {M}_{b} )}^{2}}{3}}$$

Image Performance Verification Testing

The image performance verification tests utilizing the metrics described in the previous sections rely on custom software tools used to crop the images into sub-images, calculate the metrics and finally calculate statistics on the metrics to demonstrate that each requirement is met. These software verification tools are described below and are under configuration in the Tools repository. The description below provides the context of how the tools are integrated into the verification test cases. The verification tests are largely divided into two major groups, metric calculations with a set of digital phantom images and metric calculations with a set of images obtained clinically. Within each set of test images, some metrics will be calculated on individual phantom targets or vessel segment sub-images. Some metrics will be calculated on the entire image, as described herein.

The set of Digital Phantom Images consists of 2520 Targets. These targets represent the extreme range of size, shape, and contrast of vessels encountered clinically, as well as a range of relevant background tissue conditions. Because the model is mathematically generated, we have precise information about the location and size of the target for use in the RMSCR measurements. The information about the location and size of the targets is stored in a text file along with the images for later use.

The first step in the verification testing is to run the 12 individual images through the software program under verification to generate the two corresponding enhanced images.

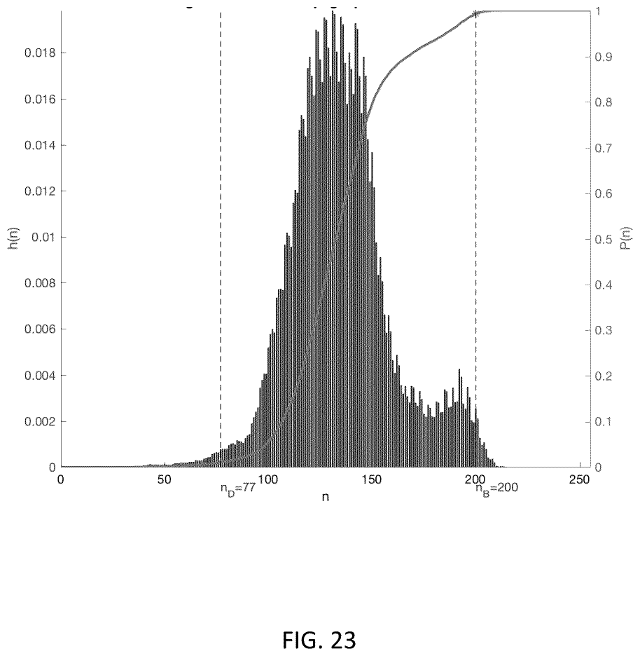

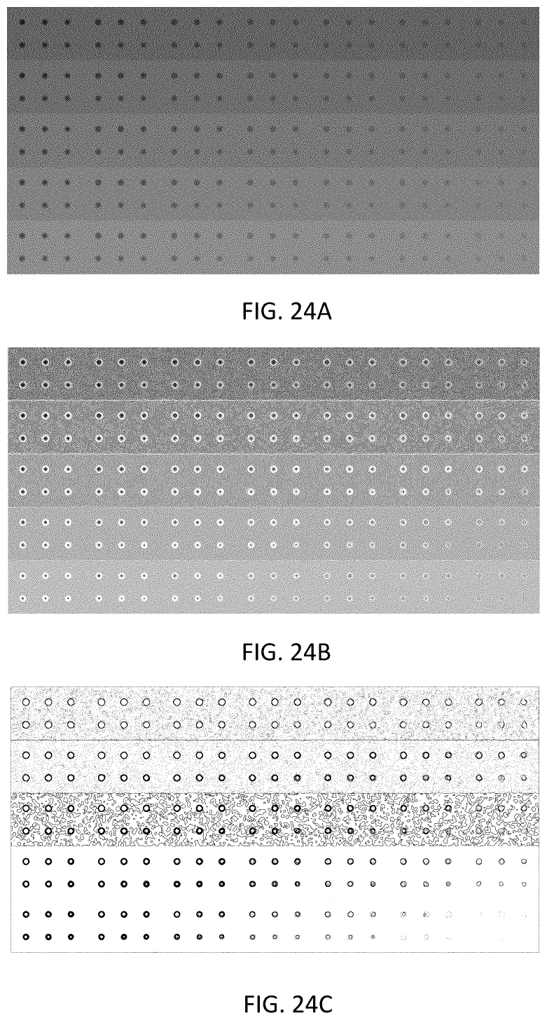

For the full image metrics (Image Contrast and Entropy), the results are stored for each input image and the two corresponding output images. FIG. 24 shows examples of the full input and output images. The resulting calculations for metric values are summarized below in Table 2.

TABLE 2
Sample Phantom Full Image Metric Results

| | | Color | Grayscale |
|---|---|---|---|
| | Input | Enhance | Enhance |
| Entropy | 5.75 | 6.06 | 2.72 |
| Entropy Enhancement % | NA | +5% | −53% |
| Image Contrast | 61 | 146 | 253 |
| Image Contrast | NA | +140% | +315% |
| Enhancement % | | | |

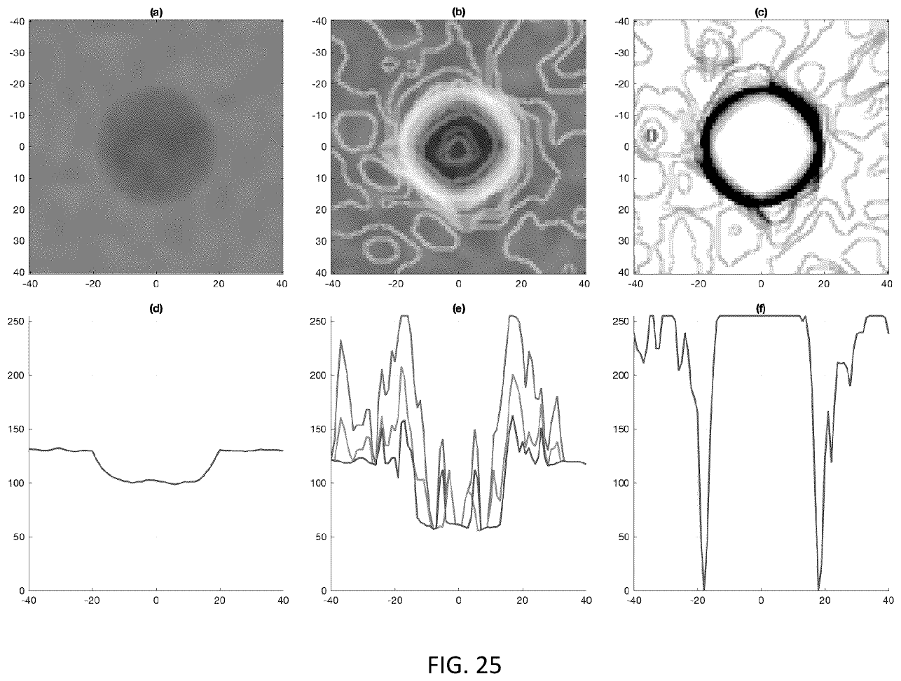

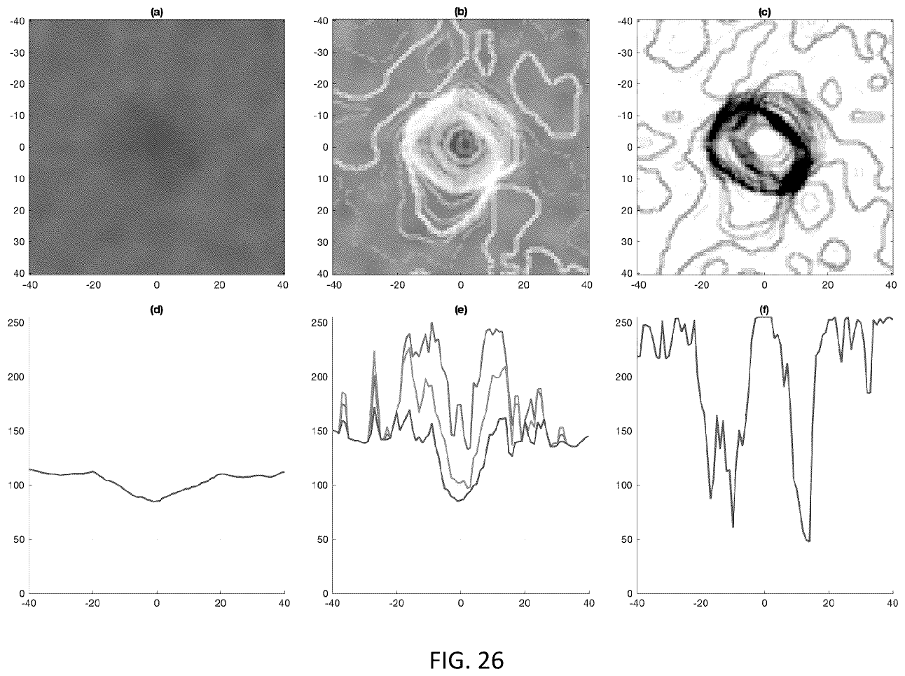

Next, the software tool performs the calculations of the metrics, which are calculated on a target basis (RMS Target Contrast Ratio, RMS Edge Contrast Ratio, and Sharpness). To do this, the software tool must first extract each individual target sub-image from the full image using the location information stored in the text file and then apply each metric calculation. The results for each sub-image (input, color out, and grayscale out) are stored for each Metric. FIG. 25, panels (a)-(f) and FIG. 26, panels (a)-(f) show examples of the input and output sub-images for two different phantom targets.

In Table 3, Sample results for the three target-based metric calculations are included for the single targets shown above in FIG. 25, panels (a)-(f) and FIG. 26, panels (a)-(f).

TABLE 3
Sample Phantom Target Metric Results

| | FIG. 25 Target Analysis | | | FIG. 26 Target Analysis | | |
|---|---|---|---|---|---|---|
| | B_{μ} = 130, Cₒ = 30, rₒ = 20, pow = 4.5 | | | B_{μ} = 110, Cₒ = 20, rₒ = 20, pow = 1.5 | | |
| | | Color | Grayscale | | Color | Grayscale |
| Metric | Input | Enhance | Enhance | Input | Enhance | Enhance |
| RMSCR_T | 0.153 | 0.438 | 0.489 | 0.089 | 0.336 | 0.488 |
| RMSCR_T | NA | 185% | 219% | NA | 277% | 448% |
| Enhancement % | | | | | | |
| RMSCR_E | 0.104 | 0.474 | 0.582 | 0.05 | 0.295 | 0.447 |
| RMSCR_E | NA | 355% | 458% | NA | 492% | 798% |
| Enhancement % | | | | | | |
| Sharp | 0.112 | 0.323 | 0.304 | 0.119 | 0.358 | 0.356 |
| Sharp | NA | 189% | 172% | NA | 201% | 199% |
| Enhancement % | | | | | | |

Once each metric has been calculated for each of the three images or sub-images, the direct comparison needed to test the requirement is calculated. This involves taking the ratio of the output metric to the input metric and calculating the percent increase (for all contrast metrics, sharpness, and color entropy) or decrease (for grayscale entropy)). Statistics on these calculations over all images or sub-images are then calculated as described elsewhere herein.

A set of clinically obtained images will also be used in the performance verification testing. These images will come from a larger set of data acquired through two separate IRB-approved retrospective Image Acquisition efforts. These two data acquisition protocols specify the collection of digital X-Ray angiography images for use in development and testing of Imago's products. A small portion of the collected images are being used in the development of the software program, and the remainder are being set aside for future use in the verification and validation testing. Data from subjects evaluated for Coronary Artery Disease (CAD) using X-Ray angiography is to be collected. The collected cases are distributed between three groups: Group 1. Normal Cases (finding of nonobstructive CAD in angiography), Group 2. Single-lesion Cases (finding of single lesion of indeterminate significance) including an FFR/iFR assessment of each lesion of either Non-significant or Significant Stenosis, and Group 3 Severe cases (findings of high-grade multi-vessel or tandem lesion disease). Between the two protocols, data will be collected from up to 7 different Image Collection Centers. In selecting the participating Image Collection Centers, the goal is to collect cases representing geographically diversity in patient populations and diversity in model and/or manufacturer of the X-ray angiography equipment.

For verification of the software program, the clinical verification test set will consist of 50 full angiogram frames selected at random from the larger data set described above, and which were not used in development. The random selection will ensure a balance of representative normal and diseased vessel cases according to the groups described in the Image Acquisition protocols as well as from multiple equipment manufacturers/models and clinical sites. This will ensure that the test image data set used to verify performance accurately represents a range of patient demographics, image acquisition conditions, and imaging devices present.

Once the image verification test set is established, a subset of target vessel segments will be defined by selecting a variety of vessel segments from each of the input images. These vessel segments are selected prior to processing the input images with the tested algorithms so as not to bias the selection.

During the selection of vessel segments, sample sub-images are created by taking the vessel segment and rotating to align the marked segment vertically in the test tool “ClinicalSubImageSelect.” At this time, the test preparation engineer using the tool visually locates the edges of the vessels with marked lines. Once the test engineer is satisfied with the marked edges, the coordinates of the vessel, including the angle of rotation and location of edges, are stored for future use. Subsequent segments are identified within each test image and stored, and then the process is repeated for all remaining images in the clinical test set. At the end of this preparation process, the set of clinical test input data will include, under configuration, the set of 50 full clinical images to be used as inputs and a text file storing the information about each vessel segment (250 segments), including the coordinates of its center and edges as well as the rotation angle to realign the vessel segment vertically.

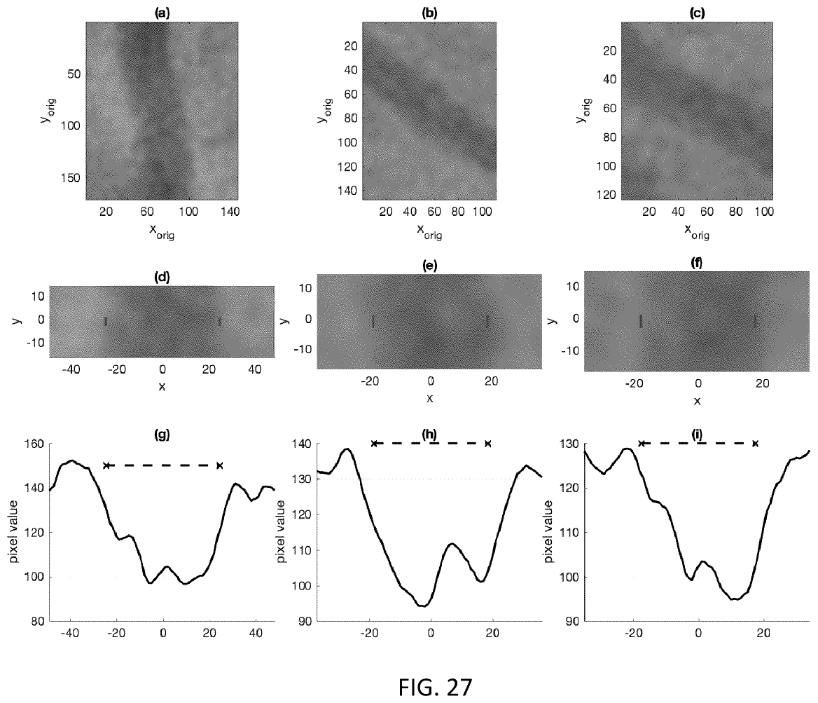

Examples of three vessel areas selected from one image are shown above in FIG. 27, panels (a)-(c). In FIG. 27, panels (d)-(f), each vessel segment from within the above sub-image is shown below after the rotation process. The red lines indicate the edges of the vessel segments as selected during the preparation process. FIG. 27, panels (g)-(i) shows the corresponding cross-sections for the average of vessel segments along the red line in the vessel segment image shown above. The dashed line shown along the cross-section plot indicates the extent of the vessel, i.e., left and right edges as marked by the tool user.

At the time of verification testing, the first step to calculate the clinical image performance metrics is to process each full test image with the software release under verification and generate the two corresponding Enhanced Output images. Once the outputs have been generated, a second Tool is used to prepare the sub-images and calculate the metrics on each full image and sub-image as appropriate for each of the original Angiogram (Input), Color Enhanced Output, and Grayscale Enhanced Output. The text file containing each vessel sub-image and segment coordinates, which was generated previously, is now used by the tool. The full image metrics (Image Contrast and Entropy) are calculated on each full image. The tool prepares the sub-images for the original input and each output and applies the target metrics calculations (RMS Target Contrast Ratio, RMS Edge Contrast Ratio, and Sharpness).

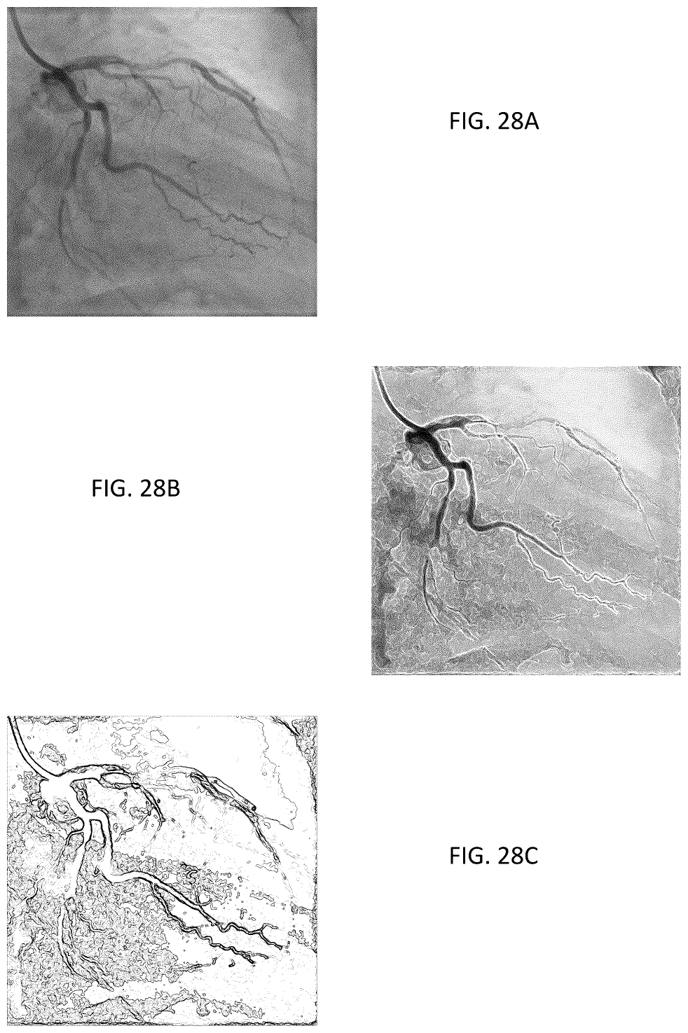

FIG. 28 shows a sample input Angiogram and two enhanced outputs and the resultant full-image. Metric calculations for that image are summarized below in Table 4.

TABLE 4
Sample Clinical Full Image Metric Results

| | | Color | Grayscale |
|---|---|---|---|
| | Input | Enhance | Enhance |
| Entropy | 6.6 | 6.8 | 4.0 |
| Entropy Enhancement % | NA | +4% | −39% |
| Image Contrast | 120 | 192 | 253 |
| Image Contrast | NA | 60% | 111% |
| Enhancement % | | | |

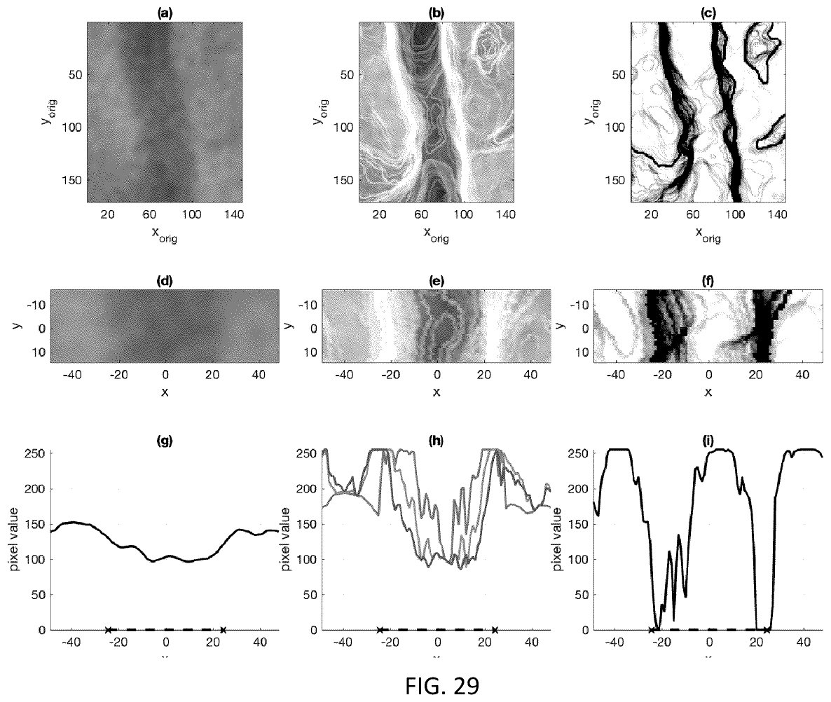

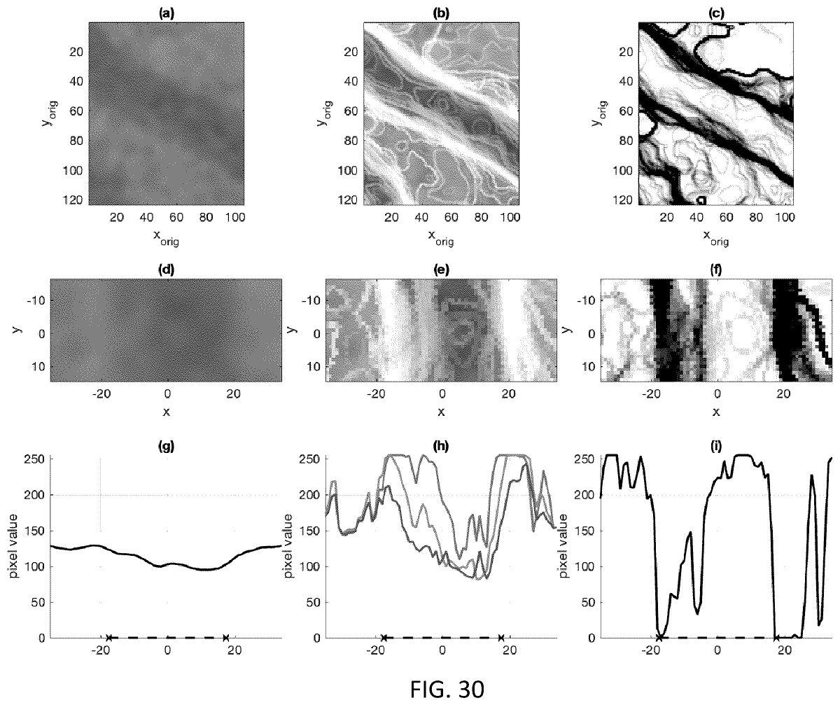

As with the phantom metric calculations, the clinical metric tool then calculates each of the target-based metrics for each vessel segment recorded for each of the inputs and the two outputs. The metric tool uses the stored vessel segment information to prepare each vessel segment sub-image and calculate the resultant metric. Example results are shown below in FIGS. 29-30 and Table 5.

TABLE 5
Sample Clinical Target Metric Results

| | Vessel Segment FIG. 29 | | | Vessel Segment FIG. 30 | | |
|---|---|---|---|---|---|---|
| | | Color | Grayscale | | Color | Grayscale |
| | Input | Enhance | Enhance | Input | Enhance | Enhance |
| RMSCR_T | 0.24 | 0.43 | 0.50 | 0.17 | 0.41 | 0.59 |
| RMSCR_T | NA | 81% | 110% | NA | 145% | 255% |
| Enhancement % | | | | | | |
| RMSCR_E | 0.21 | 0.27 | 0.66 | 0.14 | 0.24 | 0.65 |
| RMSCR_E | NA | 28% | 217% | NA | 71% | 363% |
| Enhancement % | | | | | | |
| Sharp | 0.12 | 0.36 | 0.31 | 0.10 | 0.36 | 0.31 |
| Sharp | NA | 190% | 154% | NA | 246% | 202% |
| Enhancement % | | | | | | |

Once each metric has been calculated for each of the three sub-images the direct comparison needed to test the requirement is calculated. This involves taking the ratio of the output metric to the input metric and calculating the percent increase (for all contrast metrics, sharpness, and color entropy) or decrease (for grayscale entropy)). Statistics on these calculations over all images or sub-images are then calculated as described herein.

After the calculation of all metrics, each tool saves the data in the form of two tables, one for full image metrics (row for each full image) and one for vessel segment metrics (one row for each vessel segment). There is also an archive of sub-images and graphs for optional inspection by the test engineer. The analysis of each enhancement relies on a comparison of the percent increase (or decrease) between the calculated value in the output compared to the input in order to determine whether the requirement is met. Due to the large number of targets and images between the two data sets, it is not practical for the test engineer to manually check each target. Therefore, for each calculated metric, the comparison with the input image metric is first calculated directly by each test tool, and each sub-image or full image is determined to have met or not met the requirement. After all of the calculations are complete, the software proceeds to calculate the total number of target/vessel segments or full images which meet the requirement, and depending on the tolerance specified in the requirement, that portion of the test is deemed to pass or fail accordingly. The verification test protocol contains multiple tests, which are organized based on the two test data sets (phantom and clinical) with detailed instructions for the test engineer to perform the use of the test tool and steps to verify that each requirement is being met.

Two requirements in the image performance section are not covered by tests that utilize an image performance metric, and these tests are briefly described here. The first is the requirement to have two separate output files for each input file (i.e., one for each of the two different algorithms), which is easily tested by inspection.

The second test verifies the CPV lines. The presence of the CPV lines in the enhanced images is integral to the overall image performance. Each of the metrics described in Section 3 quantifies the contrast, sharpness, and entropy changes described in the corresponding requirements, however, this additional non-metric verification test, is needed to test the requirement, describing the CPV Lines present in the output. This test does not use the clinical or phantom data set, but instead uses test images with a series of gradient bars. After running the test images through the software program, the tester uses a graphical program to identify the location of grayscale areas on the input test gradient bar and verifies that the same area is represented on the output image by a CPV line. It further tests the location and separation of different CPV lines when grayscale neighborhoods are larger or smaller as well as the differences between the number of CPV lines between the two enhanced outputs.

FIG. 31 shows an example of the test images to be used in the CPV line test. In FIG. 31A, a test input image containing a linear grayscale gradient (left) is processed and the two outputs are displayed alongside it. In the second set of images in FIG. 31A the grayscale gradient input image has the same minimum and maximum pixel values as previously, however the gradient is non-linear such that the dark areas are larger. In the corresponding output images, the CPV lines are shifted according to the change in grayscale values in the input image. The test will include a series of gradient bars, similar to those shown in FIG. 31, for which the tester will record the agreement of CPV lines on each output and grayscale areas on the input according to the desired requirement.

As described herein, the inventors have developed several software tools to perform the image performance calculations on a set of test images in a repeatable manner in order to verify that the algorithms meet the requirements and to ensure that future software changes will not negatively impact image quality.

### Illustration of Subject Technology as Clauses

Various examples of aspects of the disclosure are described as numbered clauses (1, 2, 3, etc.) for convenience. These are provided as examples, and do not limit the subject technology. Identifications of the figures and reference numbers are provided below merely as examples and for illustrative purposes, and the clauses are not limited by those identifications.

Clause 1: A method for visualizing luminance variance for an object, the method comprising: receiving image data associated with a digital input image of the object; and applying an algorithm to the image data to generate an enhanced image comprising connected pixel value (CPV) lines representative of pixel value ranges from the input image to enable visualization of the luminance variance of the object by the human eye.

Clause 2: The method of clause 1, wherein the algorithm comprises: applying a smoothing function to the image data to obtain a smoothed image; applying a non-linear transfer function to the smoothed image to obtain changes in values of the luminance variance associated with the input image; and applying a bi-directional derivative operator to the changes to obtain the enhanced image, wherein the enhanced image comprises the connected pixel values.

Clause 3: The method of any of the preceding clauses, wherein the non-linear transfer function is configured to change pixel values non-linearly.

Clause 4: The method of any of the preceding clauses, wherein, the luminance variance corresponds to changes in local luminance values in the input image.

Clause 5: The method of any of the preceding clauses, wherein in the enhanced image, a magnitude of luminance variance of pixels is mapped to a grayscale or a color palette.

Clause 6: The method of any of the preceding clauses, wherein the magnitude of luminance variance of pixels is mapped to a color palette and the color palette is selected for human vision perception.

Clause 7: The method of any of the preceding clauses, wherein the magnitude of density of luminance variance is mapped to the grayscale, wherein relatively higher pixel values in the grayscale are indicative of relatively higher values of the luminance variance in the input image.

Clause 8: The method of any of the preceding clauses, wherein the object is a body tissue including vasculature, wherein the magnitude of luminance variance of pixels is mapped to the grayscale, and wherein darkest pixels in the enhanced image correspond to lumen margins of the vasculature.

Clause 9: The method of any of the preceding clauses, wherein a distance between adjacent connected pixel value lines in the enhanced image is indicative of a rate of change of the luminance variance in pixel values in the input image.

Clause 10: The method of any of the preceding clauses, wherein the luminance variance corresponds to changes in luminance values in the input image, wherein a distance between adjacent connected pixel value lines in the enhanced image is indicative of a rate of change in luminance values in the input image, and wherein the rate of change in luminance values in the input image is indicative of fluid flow in the object.

Clause 11: The method of any of the preceding clauses, wherein closeness or separation of the CPV lines is indicative of delineation between regions of similarity.

Clause 12: The method of any of the preceding clauses, wherein closeness or separation of the CPV lines conveys structural meaning associated with patterns in the object.

Clause 13: The method of any of the preceding clauses, wherein closeness or separation of the CPV lines is indicative of a directionality of change of luminance values.

Clause 14: The method of any of the preceding clauses, wherein the input image is an X-ray angiogram.

Clause 15: The method of any of the preceding clauses, wherein the input image is a heart ultrasound image.

Clause 16: The method of any of the preceding clauses, wherein the input image is a CT scan.

Clause 17: A method for visualizing changes in an object, the method comprising: receiving image data comprising one or more frames including a digital input image of the object; applying a smoothing function to the image data to obtain a smoothed image; applying a non-linear transfer function to the smoothed image to obtain changes in values of a selected image-related parameter associated with the input image; and applying a bi-directional derivative operator to the changes to obtain an enhanced image, in which a magnitude of the image-related parameter of pixels is mapped to a grayscale or a color palette, wherein the enhanced image comprises connected pixel value lines.

Clause 18: The method of clause 17, wherein the input image comprises a grayscale image.

Clause 19: The method of one of clauses 17-18, further comprising dividing the image data into class intervals, each class interval representing a range of grayscale pixel values; and generating a histogram based on the class intervals, wherein applying the smoothing function comprises a applying a blurring function based on the histogram.

Clause 20: The method of any one of clauses 17-19, wherein the non-linear transfer function is configured to change pixel values non-linearly.

Clause 21: The method of any one of clauses 17-20, wherein the magnitude of the image-related parameter of pixels is mapped to a color palette and the color palette is selected for optimal human vision perception and/or machine learning performance.

Clause 22: The method of any one of clauses 17-21, wherein magnitude of the image-related parameter of pixels is mapped to the grayscale, wherein relatively higher pixel values in the grayscale are indicative of relatively higher parameter values in the input image.

Clause 23: The method of any one of clauses 17-22, wherein the object is a body tissue including, vasculature.

24: The method of any one of clauses 17-23, wherein the selected image parameter is luminance.

Clause 25: The method of any one of clauses 17-24, wherein a distance between adjacent connected pixel value lines in the enhanced image is indicative of a rate of change in luminance in the input image.

Clause 26: A method of imaging vasculature in a body tissue, the method comprising: receiving image data comprising one or more frames including a digital input image of the body tissue; applying an algorithm to the image data to generate an enhanced image comprising connected pixel value lines representative of pixel value ranges from the input image to enable visualization of a fluid flow-related parameter associated with the body tissue by human eye.

Clause 27: The method of clause 26, further comprising: applying a smoothing function to the image data to obtain a smoothed image; applying a non-linear transfer function to the smoothed image to obtain changes in values of a fluid flow-related parameter associated with the input image; and applying a bi-directional derivative operator to the changes to obtain the enhanced image, wherein the enhanced image comprises the connected pixel values.

Clause 28: The method of any one of clauses 26-27, wherein the non-linear transfer function is configured to map a magnitude of an image-related parameter of pixels to a grayscale or a color palette.

Clause 29: The method of any one of clauses 26-28, wherein the input image is a grayscale image of the body tissue selected from the group consisting of: an X-ray angiogram, a heart ultrasound image, a CT scan image, a PET image, an MRI image, a hyperspectral image, a mm-wave image, and an IR image, and wherein a distance between adjacent connected pixel value lines in the enhanced image is indicative of a rate of change in luminance values in the input image.

Clause 30: The method of any one of clauses 26-29, wherein the rate of change in luminance values in the input image is indicative of one or more of directionality and acceleration of fluid flow in the body tissue.

Clause 31: The method of any one of clauses 26-30, wherein the body tissue includes vasculature, wherein the magnitude of the image-related parameter of pixels is mapped to the grayscale, and wherein darkest pixels in the enhanced image correspond to lumen of the vasculature.

Clause 32: The method of any one of clauses 26-31, wherein relatively higher pixel values in the grayscale are indicative of relatively higher parameter values in the input image.

Clause 33: A system comprising: one or more memory units each operable to store at least one program; and at least one processor communicatively coupled to the one or more memory units, in which the at least one program, when executed by the at least one processor, causes the at least one processor to perform the steps according to the method of any of clauses 1-16.

Clause 34: A non-transitory computer readable storage medium having stored thereon computer-executable instructions which, when executed by a processor, perform the steps according to the method of any one of clauses 1-16.

Clause 35: A system comprising: one or more memory units each operable to store at least one program; and at least one processor communicatively coupled to the one or more memory units, in which the at least one program, when executed by the at least one processor, causes the at least one processor to perform the steps according to the method of any one of clauses 17-25.

Clause 36: A non-transitory computer readable storage medium having stored thereon computer-executable instructions which, when executed by a processor, perform the steps according to the method of any one of clauses 17-25.

Clause 37: A system comprising: one or more memory units each operable to store at least one program; and at least one processor communicatively coupled to the one or more memory units, in which the at least one program, when executed by the at least one processor, causes the at least one processor to perform the steps according to the method of any one of clauses 26-32.

Clause 38: A non-transitory computer readable storage medium having stored thereon computer-executable instructions which, when executed by a processor, perform the steps according to the method of any one of clauses 26-32.

In some embodiments, any of the clauses herein may depend from any one of the independent clauses or any one of the dependent clauses. In one aspect, any of the clauses (e.g., dependent or independent clauses) may be combined with any other one or more clauses (e.g., dependent or independent clauses). In one aspect, a claim may include some or all of the words (e.g., steps, operations, means or components) recited in a clause, a sentence, a phrase or a paragraph. In one aspect, a claim may include some or all of the words recited in one or more clauses, sentences, phrases or paragraphs. In one aspect, some of the words in each of the clauses, sentences, phrases or paragraphs may be removed. In one aspect, additional words or elements may be added to a clause, a sentence, a phrase or a paragraph. In one aspect, the subject technology may be implemented without utilizing some of the components, elements, functions or operations described herein. In one aspect, the subject technology may be implemented utilizing additional components, elements, functions or operations.

As used herein, the word “module” refers to logic embodied in hardware or firmware, or to a collection of software instructions, possibly having entry and exit points, written in a programming language, such as, for example C++. A software module may be compiled and linked into an executable program, installed in a dynamic link library, or may be written in an interpretive language such as BASIC. It will be appreciated that software modules may be callable from other modules or from themselves, and/or may be invoked in response to detected events or interrupts. Software instructions may be embedded in firmware, such as an EPROM or EEPROM. It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware.

It is contemplated that the modules may be integrated into a fewer number of modules. One module may also be separated into multiple modules. The described modules may be implemented as hardware, software, firmware or any combination thereof. Additionally, the described modules may reside at different locations connected through a wired or wireless network, or the Internet.

In general, it will be appreciated that the processors can include, by way of example, computers, program logic, or other substrate configurations representing data and instructions, which operate as described herein. In other embodiments, the processors can include controller circuitry, processor circuitry, processors, general purpose single-chip or multi-chip microprocessors, digital signal processors, embedded microprocessors, microcontrollers and the like.

Furthermore, it will be appreciated that in one embodiment, the program logic may advantageously be implemented as one or more components. The components may advantageously be configured to execute on one or more processors. The components include, but are not limited to, software or hardware components, modules such as software modules, object-oriented software components, class components and task components, processes methods, functions, attributes, procedures, subroutines, segments of program code, drivers, firmware, microcode, circuitry, data, databases, data structures, tables, arrays, and variables.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

There may be many other ways to implement the subject technology. Various functions and elements described herein may be partitioned differently from those shown without departing from the scope of the subject technology. Various modifications to these configurations will be readily apparent to those skilled in the art, and generic principles defined herein may be applied to other configurations. Thus, many changes and modifications may be made to the subject technology, by one having ordinary skill in the art, without departing from the scope of the subject technology.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

Terms such as “top,” “bottom,” “front,” “rear” and the like as used in this disclosure should be understood as referring to an arbitrary frame of reference, rather than to the ordinary gravitational frame of reference. Thus, a top surface, a bottom surface, a front surface, and a rear surface may extend upwardly, downwardly, diagonally, or horizontally in a gravitational frame of reference.

Furthermore, to the extent that the term “include,” “have,” or the like is used in the description or the claims, such term is intended to be inclusive in a manner similar to the term “comprise” as “comprise” is interpreted when employed as a transitional word in a claim.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

Although the detailed description contains many specifics, these should not be construed as limiting the scope of the subject technology but merely as illustrating different examples and aspects of the subject technology. It should be appreciated that the scope of the subject technology includes other embodiments not discussed in detail above. Various other modifications, changes and variations may be made in the arrangement, operation and details of the method and apparatus of the subject technology disclosed herein without departing from the scope of the present disclosure. In addition, it is not necessary for a device or method to address every problem that is solvable (or possess every advantage that is achievable) by different embodiments of the disclosure in order to be encompassed within the scope of the disclosure. The use herein of “can” and derivatives thereof shall be understood in the sense of “possibly” or “optionally” as opposed to an affirmative capability.

What is claimed is:

1. A method for visualizing luminance variance for an object, the method comprising:
receiving image data associated with a digital input image of the object; and
applying an algorithm to the image data to generate an enhanced image comprising connected pixel value (CPV) lines representative of pixel value ranges from the input image to enable visualization of the luminance variance of the object by the human eye.

2. The method of claim 1, wherein the algorithm comprises:
applying a smoothing function to the image data to obtain a smoothed image;
applying a non-linear transfer function to the smoothed image to obtain changes in values of the luminance variance associated with the input image; and
applying a bi-directional derivative operator to the changes to obtain the enhanced image, wherein the enhanced image comprises the connected pixel values.

3. The method of claim 2, wherein the non-linear transfer function is configured to change pixel values non-linearly.

4. The method of claim 2, wherein, the luminance variance corresponds to changes in local luminance values in the input image.

5. The method of claim 2, wherein in the enhanced image, a magnitude of luminance variance of pixels is mapped to a grayscale or a color palette.

6. The method of claim 5, wherein the magnitude of luminance variance of pixels is mapped to a color palette, and the color palette is selected for human vision perception.

7. The method of claim 5, wherein the magnitude of density of luminance variance is mapped to the grayscale, wherein relatively higher pixel values in the grayscale are indicative of relatively higher values of the luminance variance in the input image.

8. The method of claim 5, wherein the object is a body tissue including vasculature, wherein the magnitude of luminance variance of pixels is mapped to the grayscale, and wherein darkest pixels in the enhanced image correspond to lumen margins of the vasculature.

9. The method of claim 1, wherein a distance between adjacent connected pixel value lines in the enhanced image is indicative of a rate of change of the luminance variance in pixel values in the input image.

10. The method of claim 1, wherein the luminance variance corresponds to changes in luminance values in the input image, wherein a distance between adjacent connected pixel value lines in the enhanced image is indicative of a rate of change in luminance values in the input image, and wherein the rate of change in luminance values in the input image is indicative of fluid flow in the object.

11. The method of claim 1, wherein closeness or separation of the CPV lines is indicative of delineation between regions of similarity.

12. The method of claim 1, wherein closeness or separation of the CPV lines conveys structural meaning associated with patterns in the object.

13. The method of claim 1, wherein closeness or separation of the CPV lines is indicative of a directionality of change of luminance values.

14. The method of claim 1, wherein the input image is an X-ray angiogram.

15. The method of claim 1, wherein the input image is a heart ultrasound image.

16. The method of claim 1, wherein the input image is a CT scan.

17. A method for visualizing changes in an object, the method comprising:
receiving image data comprising one or more frames including a digital input image of the object;
applying a smoothing function to the image data to obtain a smoothed image;
applying a non-linear transfer function to the smoothed image to obtain changes in values of a selected image-related parameter associated with the input image; and
applying a bi-directional derivative operator to the changes to obtain an enhanced image, in which a magnitude of the image-related parameter of pixels is mapped to a grayscale or a color palette,
wherein the enhanced image comprises connected pixel value lines.

18. The method of claim 17, wherein the input image comprises a grayscale image.

19. The method of claim 18, further comprising dividing the image data into class intervals, each class interval representing a range of grayscale pixel values; and
generating a histogram based on the class intervals,
wherein applying the smoothing function comprises a applying a blurring function based on the histogram.

20. The method of claim 18, wherein the non-linear transfer function is configured to change pixel values non-linearly.

21. The method of claim 17, wherein the magnitude of the image-related parameter of pixels is mapped to a color palette and the color palette is selected for optimal human vision perception and/or machine learning performance.

22. The method of claim 17, wherein magnitude of the image-related parameter of pixels is mapped to the grayscale, wherein relatively higher pixel values in the grayscale are indicative of relatively higher parameter values in the input image.

23. The method of claim 17, wherein the object is a body tissue including, vasculature.

24. The method of claim 23, wherein the selected image parameter is luminance.

25. The method of claim 24, wherein a distance between adjacent connected pixel value lines in the enhanced image is indicative of a rate of change in luminance in the input image.

26. A method of imaging vasculature in a body tissue, the method comprising:
receiving image data comprising one or more frames including a digital input image of the body tissue;
applying an algorithm to the image data to generate an enhanced image comprising connected pixel value lines representative of pixel value ranges from the input image to enable visualization of a fluid flow-related parameter associated with the body tissue by the human eye.

27. The method of claim 26, further comprising:
applying a smoothing function to the image data to obtain a smoothed image;
applying a non-linear transfer function to the smoothed image to obtain changes in values of a fluid flow-related parameter associated with the input image; and
applying a bi-directional derivative operator to the changes to obtain the enhanced image, wherein the enhanced image comprises the connected pixel values.

28. The method of claim 27, wherein the non-linear transfer function is configured to map a magnitude of an image-related parameter of pixels to a grayscale or a color palette.

29. The method of claim 28, wherein the input image is a grayscale image of the body tissue selected from the group consisting of: an X-ray angiogram, a heart ultrasound image, a CT scan image, a PET image, an MRI image, a hyperspectral image, a mm-wave image, and an IR image, and
wherein a distance between adjacent connected pixel value lines in the enhanced image is indicative of a rate of change in luminance values in the input image.

30. The method of claim 29, wherein the rate of change in luminance values in the input image is indicative of one or more of directionality and acceleration of fluid flow in the body tissue.

31. The method of claim 26, wherein the body tissue includes vasculature, wherein the magnitude of the image-related parameter of pixels is mapped to the grayscale, and wherein darkest pixels in the enhanced image correspond to lumen of the vasculature.

32. The method of claim 26, wherein relatively higher pixel values in the grayscale are indicative of relatively higher parameter values in the input image.

33. A system comprising:
one or more memory units, each operable to store at least one program; and
at least one processor communicatively coupled to one or more memory units, in which the at least one program, when executed by at least one processor, causes at least one processor to perform the steps according to the method of claim 1.

34. A non-transitory computer-readable storage medium having stored thereon computer-executable instructions which, when executed by a processor, perform the steps according to the method of claim 1.

35. A system comprising:
one or more memory units each operable to store at least one program; and
at least one processor communicatively coupled to the one or more memory units, in which the at least one program, when executed by the at least one processor, causes the at least one processor to perform the steps according to the method of claim 17.

36. A non-transitory computer readable storage medium having stored thereon computer-executable instructions which, when executed by a processor, perform the steps according to the method of claim 17.

37. A system comprising:
one or more memory units, each operable to store at least one program; and
at least one processor communicatively coupled to the one or more memory units, in which the at least one program, when executed by at least one processor, causes at least one processor to perform the steps according to the method of claim 26.

38. A non-transitory computer-readable storage medium having stored thereon computer-executable instructions which, when executed by a processor, perform the steps according to the method of claim 26.
